(19) United States
(12) Patent Application Publication
(10) Pub. No.: US 2011/0051037 A1
(43) Pub. Date: Mar. 3, 2011

(54) OPTICAL ASSEMBLY, BACKLIGHT UNIT, AND DISPLAY DEVICE

(76) Inventors: Sungwoo Kim, Seoul (KR); Soonhyung Kwon, Seoul (KR); Bupsung Jung, Seoul (KR); Seungchoon Bae, Seoul (KR); Sangtae Park, Seoul (KR); Buwan Seo, Seoul (KR)

(21) Appl. No.: 12/860,849

(22) Filed: Aug. 20, 2010

Related U.S. Application Data
(60) Provisional application No. 61/320,725, filed on Apr. 3, 2010.
(60) Provisional application No. 61/237,587, filed on Aug. 27, 2009.

(30) Foreign Application Priority Data
Aug. 27, 2009 (KR) 10-2009-0079700
Aug. 27, 2009 (KR) 10-2009-0079710
Aug. 28, 2009 (KR) 10-2009-0080249
Nov. 24, 2009 (KR) 10-2009-0114225
Nov. 24, 2009 (KR) 10-2009-0114226
Nov. 24, 2009 (KR) 10-2009-0114227
Jan. 18, 2010 (KR) 10-2010-0004454

(51) Int. Cl. G02F 1/13357; F21V 7/00; G09F 13/04

(52) U.S. Cl. 349/62; 362/235; 362/97.1

(57) ABSTRACT

An optical assembly, a backlight unit including the optical assembly, and a display device including the backlight unit are discussed. According to an embodiment, a light generating device such as a backlight unit includes a first layer; a plurality of light source devices disposed on the first layer and configured to emit light from side surfaces of the light source devices, at least one of the light source devices having a light emitting diode and at least one lead electrode electrically connected to the light emitting diode, each of the at least one lead electrode being disposed in at least one lead electrode area of the corresponding light source device; a reflection layer configured to reflect the light emitted from the light source devices, the reflection layer disposed on the first layer and defining at least one predetermined gap between the at least one lead electrode area of the corresponding light source device and the reflection layer; and a second layer covering the light source devices and the reflection layer.

This application claims the priority benefit of Korean Patent Application Nos. 10-2009-0079710 filed on Aug. 27, 2009, 10-2009-0079700 filed on Aug. 27, 2009, 10-2009-0080249 filed on Aug. 28, 2009, 10-2009-0114226 filed on Nov. 24, 2009, 10-2009-0114227 filed on Nov. 24, 2009, 10-2009-0114225 filed on Nov. 24, 2009, and 10-2010-0004454 filed on Jan. 18, 2010, U.S. Provisional Application Nos. 61/320,725 filed on Apr. 5, 2010, and 61/237,587 filed on Aug. 27, 2009, which is incorporated herein by reference for all purposes as if fully set forth herein.

### BACKGROUND OF THE INVENTION

1. Field of the Invention

Exemplary embodiments of the invention relate to an optical assembly, a backlight unit including the optical assembly, and a display device including the backlight unit.

2. Description of the Related Art

Liquid crystal displays have been widely used in various fields including the notebook PC market and the monitor market because of excellent characteristics such as thin profile, lightness in weight, and low power consumption.

The liquid crystal display includes a liquid crystal display panel and a backlight unit providing light to the liquid crystal display panel. The liquid crystal display panel transmits light provided by the backlight unit and adjusts a transmittance of the light, thereby displaying an image.

The backlight unit may be classified into an edge type backlight unit and a direct type backlight unit depending on a location of light sources. In the edge type backlight unit, light sources are disposed at the side of the liquid crystal display panel, and a light guide plate is disposed on a back surface of the liquid crystal display panel and guides the light emitted from the side of the liquid crystal display panel to the back surface of the liquid crystal display panel. In the direct type backlight unit, light sources are disposed on a back surface of the liquid crystal display panel, and the light emitted from the light sources may be directly provided to the back surface of the liquid crystal display panel.

Examples of the light sources may include an electroluminescence (EL) device, a cold cathode fluorescent lamp (CCFL), a hot cathode fluorescent lamp (HCFL), and a light emitting diode (LED). The LED has low power consumption and high light emitting efficiency.

### SUMMARY OF THE INVENTION

Exemplary embodiments of the invention provide an optical assembly, a backlight unit including the optical assembly, and a display device including the backlight unit.

Embodiments of the invention provide a light generating device including one or more light source devices each including a light emitting unit such as an LED, which can be used in a backlight unit or other device and which address the limitations and disadvantages associated with the background art.

According to an embodiment, the invention provides a light generating device comprising: a first layer; a plurality of light source devices disposed on the first layer and configured to emit light from side surfaces of the light source devices, at least one of the light source devices having a light emitting diode and at least one lead electrode electrically connected to the light emitting diode, each of the at least one lead electrode being disposed in at least one lead electrode area of the corresponding light source device; a reflection layer configured to reflect the light emitted from the light source devices, the reflection layer disposed on the first layer and defining at least one predetermined gap between the at least one lead electrode area of the corresponding light source device and the reflection layer; and a second layer covering the light source devices and the reflection layer.

According to an embodiment, the invention provides a backlight device comprising: a plurality of first arrays of light source devices and a plurality of second arrays of light source devices disposed on a first layer, the first and second arrays of light source devices configured to emit light in at least two different directions, at least one of the light source devices including a light emitting diode; a reflection layer configured to reflect the light emitted from the first and second arrays of light source devices, the reflection layer disposed on the first layer and surrounding the first and second arrays of light source devices with a plurality of predefined gaps, each of the predefined gaps provided between the reflection layer and at least one of the light source devices; and a second layer covering the reflection layer and the first and second arrays of light source devices.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIGS. 1 and 2 illustrate a display device according to an exemplary embodiment of the invention:

FIG. 3 illustrates a display module according to an exemplary embodiment of the invention:

FIGS. 4 and 5 illustrate a first exemplary configuration of a backlight unit according to an exemplary embodiment of the invention;

FIG. 6 illustrates a second exemplary configuration of a backlight unit according to an exemplary embodiment of the invention;

FIG. 7 illustrates a third exemplary configuration of a backlight unit according to an exemplary embodiment of the invention;

FIGS. 8 to 13 illustrate a fourth exemplary configuration of a backlight unit according to an exemplary embodiment of the invention;

FIGS. 14 to 17 illustrate a location of a first pattern of a backlight unit according to an exemplary embodiment of the invention;

FIGS. 18 to 21 illustrate a shape of a first pattern according to an exemplary embodiment of the invention;

FIGS. 22 and 23 illustrate a fifth exemplary configuration of a backlight unit according to an exemplary embodiment of the invention;

FIG. 24 illustrates a sixth exemplary configuration of a backlight unit according to an exemplary embodiment of the invention:

FIGS. 25 and 26 are cross-sectional views for illustrating a location relationship between a light source and a reflection layer of a backlight unit;

FIGS. 27 and 28 illustrate a structure of a light source of a backlight unit according to an embodiment of the invention;

FIG. 29 illustrates a structure of light sources of a backlight unit according to an embodiment of the invention;

FIGS. 30 to 34 illustrate a front shape of a backlight unit according to an exemplary embodiment of the invention;

FIGS. 35 to 41 illustrate a structure of a reflection layer of a backlight unit according to an exemplary embodiment of the invention;

FIGS. 42 and 43 illustrate a seventh exemplary configuration of a backlight unit according to an exemplary embodiment of the invention;

FIGS. 44 to 47 illustrate a structure of a reflection layer of the backlight unit according to the seventh exemplary configuration;

FIGS. 48 to 55 are enlarged diagrams of various examples of an area R shown in FIG. 43 according to an embodiment of the invention;

FIGS. 56A and 56B are top and side views of a light source device according to an embodiment of the invention;

FIG. 57 illustrates an eighth exemplary configuration of a backlight unit according to an exemplary embodiment of the invention; and

FIG. 58 is a cross-sectional view illustrating a configuration of a display device according to an exemplary embodiment of the invention.

### DETAILED DESCRIPTION OF THE EMBODIMENTS

Reference will now be made in detail embodiments of the invention examples of which are illustrated in the accompanying drawings. In this regard, each of all display devices, backlight units, light source devices, and any device that includes such backlight unit or light source device discussed below is operatively coupled and configured. Further, a backlight unit according to embodiments of the invention preferably is fixed to a back of a display panel and has a same or similar size as the display panel to correspond to the entire display region of the display panel. Furthermore, such a backlight unit preferably includes a plurality of light sources which are disposed in arrays, lines, patterns, etc. throughout the entire area of the backlight unit that corresponds to the entire display region of the display panel. As such, the light sources are not just located at one side of the display panel, but are preferably dispersed below throughout the entire display region of the display panel. In these figures, arrows indicate a general light emitting direction of the light source, e.g., a general direction in which the light from a light emitting surface of the light source is emitted, but the light from the light source may emit not necessarily in a single line but through an area in the indicated direction.

According to various embodiments of the invention, any one or more features from one embodiment/example/variation of the invention can be applied to (e.g. added, substituted, modified, etc.) any one or more other embodiments/examples/variations discussed below according to the invention. Further any operations/methods discussed below can be implemented in any of these devices/units or other suitable devices/units.

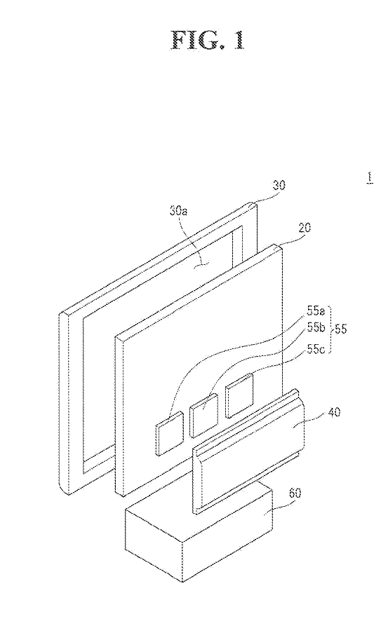

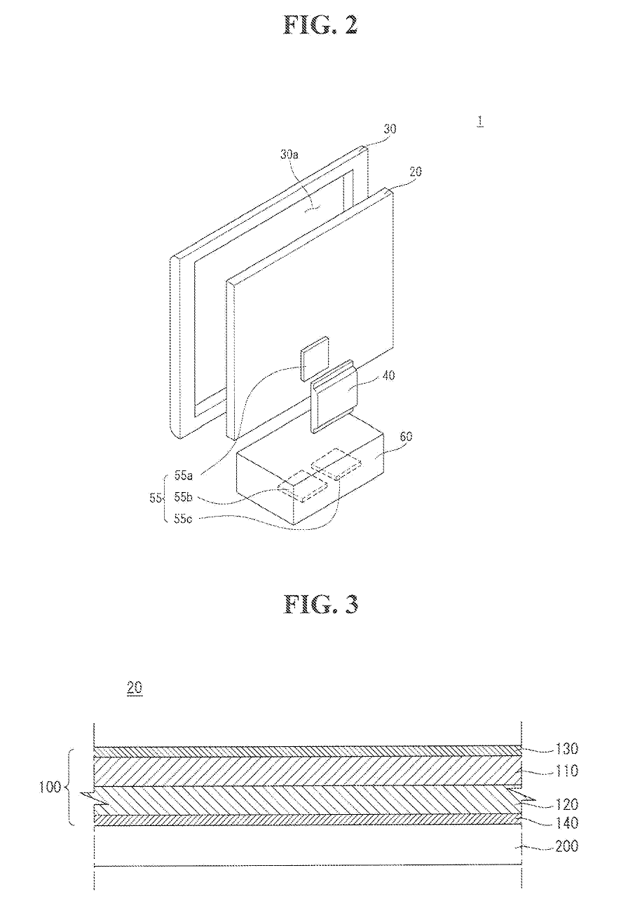

FIGS. 1 and 2 illustrate a display device according to an exemplary embodiment of the invention.

As shown in FIG. 1, a display device 1 according to an exemplary embodiment of the invention includes a display module 20, a front cover 30 covering the display module 20, a driver 55 included in the display module 20, and a back cover 40 covering the driver 55.

The front cover 30 may include a front panel formed of a transparent material capable of transmitting light. The front panel is separated from the display module 20 by a predetermined distance and protects the display module 20. The front panel transmits light emitted by the display module 20, so that a user can see an image displayed on the display module 20.

The front cover 30 may be made using a flat plate not having a window 30a. In this case, the front cover 30 is formed of a transparent material capable of transmitting light, for example, injection-molded plastic. As above, if the front cover 30 is made of the flat plate, a frame may be omitted from the front cover 30:

The driver 55 may include a driving controller 55a, a main board 55b, and a power supply unit 55c. The driving controller 55a may be a timing controller and controls operation timing of each of driver integrated circuits (ICs) of the display module 20. The main board 55h transfers a vertical synchronous signal, a horizontal synchronous signal, and a RGB resolution signal to the driving controller 55a. The power supply unit 55c applies power to the display module 20.

The driver 55 is included in the display module 20 and may be covered by the back cover 40. The display device 1 may further include a stand 60 for supporting the display device 1.

On the other hand, as shown in FIG. 2, the driving controller 55a of the driver 55 is included in the display module 20, and the main board 55b and the power supply board 55c corresponding to the power supply unit 55c may be included in the stand 60. The back cover 40 may cover only the driving controller 55a of the driver 55.

In the embodiment of the invention, the main board 55b and the power supply board 55c are separately configured. However, the main board 55b and the power supply board 55c may be configured on one integrated board. Other configurations may be used for the main hoard 55b and the power supply board 55c.

FIG. 3 illustrates an example of the display module 20. As shown in FIG. 3, the display module 20 includes a display panel 100 and a backlight unit 200.

The display panel 100 includes a color filter substrate 110 and a thin film transistor (TFT) substrate 120 that are positioned opposite each other and are attached to each other with a uniform cell gap therebetween. A liquid crystal layer is interposed between the two substrates 110 and 120.

The color filter substrate 110 includes a plurality of color filters each including red (R), green (G), and blue (B) color filters and may generate a red, green, or blue image when light is applied to the display device 1. In the embodiment of the invention, each of the color filters can include the red, green, and blue sub-color filters. Other structures may be used for a color filter corresponding to a pixel. For example, each pixel may include red, green, blue, and white (W) sub-pixels.

The TFT substrate 120 is a substrate, on which a plurality of switching elements are formed, and may switch on and off selectively a plurality of corresponding pixel electrodes. For example, a common electrode and the pixel electrode may change an arrangement of liquid crystal molecules of the liquid crystal layer depending on a predetermined voltage supplied thereto.

The liquid crystal layer is comprised of the liquid crystal molecules. The arrangement of the liquid crystal molecules varies depending on a voltage difference between the pixel electrode and the common electrode. Hence, light provided by the backlight unit 200 may be incident on the color filter substrate 110 based on changes in the arrangement of the liquid crystal molecules of the liquid crystal layer.

An upper polarizing plate 130 and a lower polarizing plate 140 may be respectively positioned on and under the display panel 100. More particularly, the upper polarizing plate 130 may be positioned on the color filter substrate 110, and the lower polarizing plate 140 may be positioned under the TFT substrate 120.

A gate driver and a data driver, each of which generates driving signals for driving the gate lines and data lines of the display panel 100, may be provided on the side of the display panel 100.

As shown in FIG. 3, the display module 20 according to the embodiment of the invention may be configured so that the backlight unit 200 adheres closely to the display panel 100. For example, the backlight unit 200 may be attached and fixed to the bottom of the display panel 100, more particularly, the lower polarizing plate 140. For this, an adhesive layer may be formed between the lower polarizing plate 140 and the backlight unit 200.

As described above, the entire thickness of the display device 1 may be reduced by attaching the backlight unit 200 close to the display panel 100, and thus an external appearance of the display device 1 may be improved. Further, because a separate structure for fixing the backlight unit 200 is removed, the structure and the manufacturing process of the display device 1 may be simplified.

Further, because a space between the backlight unit 200 and the display panel 100 is removed, foreign substances may be prevented from penetrating into the space. Hence, a malfunction of the display device 1 or a reduction in the image quality of an image displayed on the display device 1 resulting from the foreign substances may be prevented.

The backlight unit 200 according to the embodiment of the invention may have the structure in which a plurality of function layers are sequentially laminated, and at least one layer of the plurality of function layers may include a plurality of light sources.

Each of the plurality of function layers constituting the backlight unit 200 may be formed of a flexible material, so that the backlight unit 200 is closely attached and fixed to bottom of the display panel 100.

The display panel 100 according to the embodiment of the invention may be divided into a plurality of regions. A brightness of light emitted from a region of the backlight unit 200 corresponding to each of the divided regions (i.e., a brightness of the corresponding light source) is adjusted based on a gray peak value or a color coordinate signal of each divided region. Hence, a luminance of the display panel 100 may be adjusted. For this, the backlight unit 200 may operate, so that regions of the backlight unit 200 respectively corresponding to the divided regions of the display panel 100 are dividedly driven.

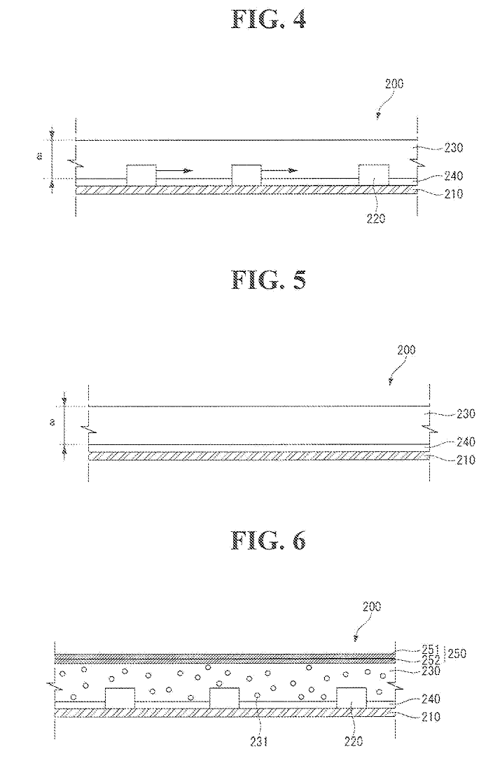

FIG. 4 illustrates a first exemplary configuration of the backlight unit 200 according to the exemplary embodiment of the invention. As shown in FIG. 4, the backlight unit 200 according to the first exemplary configuration may include a first layer 210, a plurality of light sources 220, a second layer 230, and a reflection layer 240. As mentioned above, the backlight unit 200 in this or other embodiments may have a same or similar size as the display panel 100 so that it covers the entire display area of the display panel 100. Thus the light sources 220 in this or other embodiments are provided throughout the entire area of the backlight unit 200 so that these light sources 220 are dispersed below the entire display area of the display panel 100.

The plurality of light sources 220 may be formed on the first layer 210, and the second layer 230 may be formed on the first layer 210 so as to cover the light sources 220. For instance, the second layer 230 encapsulates (covers entirely) the light sources 220 on the first layer 210.

The first layer 210 may be a substrate on which the plurality of light sources 220 are mounted. An electrode pattern for connecting the light sources 220 to an adapter for a power supply may be formed on the first layer 210. For example, a carbon nanotube electrode pattern for connecting the light sources 220 to the adapter may be formed on the first layer 210.

The first layer 210 may be formed of polyethylene terephthalate (PET), glass, polycarbonate (PC), or silicon. The first layer 210 may be a printed circuit board (PCB) substrate, on which the plurality of light sources 220 are mounted, and may be formed in a film form.

The light source 220 may be one of a light emitting diode (LED) chip and a light emitting diode package having at least one light emitting diode chip. In the embodiment of the invention, the light emitting diode package is described as an example of the light source 220.

The LED package constituting the light source 220 may be classified into a top view type LED package and a side view type LED package based on a facing direction of a light emitting surface of the LED package. In the embodiment of the invention, the light source 220 may be configured using at least one of the top view type LED package, in which the light emitting surface is upward formed, and the side view type LED package in which the light emitting surface is formed toward the side.

If the side view type LED package is used as the light source 220 in the embodiment of the invention, each of the light sources 220 may have a light emitting surface at the side thereof and may emit light in a lateral direction, i.e., in an extension direction of the first layer 210 or the reflection layer 240. Thus, a thin profile of the backlight unit 200 may be achieved by reducing a thickness “a” of the second layer 230 formed on the light sources 220. As a result, a thin profile of the display device 1 may be achieved.

The light source 220 may be configured by a colored LED emitting at least one of red light, green light, blue light, etc. or a white LED emitting white light. In addition, the colored LED may include at least one of a red LED, a blue LED, and a green LED. The disposition and emitting light of the light emitting diode may be variously changed within a technical scope of the embodiment.

The second layer 230 transmits light emitted by the light sources 220, and at the same time diffuses the light emitted by the light sources 220, thereby allowing the light sources 220 to uniformly provide the light to the display panel 100.

The reflection layer 240 is positioned on the first layer 210 and reflects light emitted by the light sources 220. The reflection layer 240 may be formed in an area excluding a formation area of the light sources 220 from the first layer 210. The reflection layer 240 reflects light emitted from the light sources 220 and again reflects light totally reflected from a boundary of the second layer 230, thereby more widely diffusing the light.

The reflection layer 240 may contain at least one of metal and metal oxide that are a reflection material. For example, the reflection layer 240 may contain metal or metal oxide having a high reflectance, such as aluminum (Al), silver (Ag), gold (Au), and titanium dioxide (TiO₂). In this case, the reflection layer 240 may be formed by depositing or coating the metal or the metal oxide on the first layer 210 or by printing a metal ink on the first layer 210. The deposition method may use a heat deposition method, an evaporation method, or a vacuum deposition method such as a sputtering method. The coating method or the printing method may use a gravure coating method or a silk screen method.

The second layer 230 on the first layer 210 may be formed of a material capable of transmitting light, for example, silicon or acrylic resin. Other materials may be used for the second layer 230. For example, various types of resin may be used. Further, the second layer 230 may be formed of a resin having a refractive index of approximately 1.4 to 1.6, so that the backlight unit 200 has a uniform luminance by diffusing the light emitted from the light sources 220. For example, the second layer 230 may be formed of any one material selected from the group consisting of polyethylene terephthalate (PET), polycarbonate (PC), polypropylene, polyethylene, polystyrene, polyepoxy, silicon, acryl, etc.

The second layer 230 may contain a polymer resin having an adhesion so as to tightly and closely adhere to the light sources 220 and the reflection layer 240. For example, the second layer 230 may contain an acrylic resin such as unsaturated polyester, methylmethacrylate, ethylmethacrylate, isobutylmethacrylate, normal butylmethacrylate, normal butyl methylmethacrylate, acrylic acid, methacrylic acid, hydroxy ethylmethacrylate, hydroxy propylmethacrylate, hydroxy ethylacrylate, acrylamide, methylol acrylamide, glycidyl methacrylate, ethylacrylate, isobutylacrylate, normal butylacrylate, 2-ethylhexyl acrylate polymer, copolymer, or terpolymer, etc., an urethane resin, an epoxy resin, a melamine resin, etc.

The second layer 230 may be formed by applying and curing a liquid or gel-type resin on the first layer 210 on which the light sources 220 and the reflection layer 240 are formed. Alternatively, the second layer 230 may be formed by applying and partially curing a resin on a support sheet and then attaching the resin to the first layer 210.

As the thickness “a” of the second layer 230 increases, light emitted from the light sources 220 may be more widely diffused. Hence, the backlight unit 200 may provide light having the uniform luminance to the display panel 100. On the other hand, as the thickness “a” of the second layer 230 increases, an amount of light absorbed in the second layer 230 may increase. Hence, the luminance of light which the backlight unit 200 provides to the display panel 100 may entirely decrease.

Accordingly, the thickness “a” of the second layer 230 may be approximately 0.1 mm to 4.5 mm, so that the backlight unit 200 can provide light having the uniform luminance to the display panel 100 without an excessive reduction in the luminance.

FIG. 5 illustrates a cross-sectional shape of an area excluding an area of the light sources 220 from the entire area of the backlight unit 200. More specifically, FIG. 4 is a cross-sectional view taking a formation area of the light sources 220 in the backlight unit 200 along line A-A′ of FIG. 30. FIG. 5 is a cross-sectional view taking the non-formation area of the light sources 220 in the backlight unit 200 along line B-B′ of FIG. 30. The formation area of the light sources 220 is an area where the light sources 220 are formed, and a non-formation area of the light sources 220 is an area where the light sources are not formed.

As shown in FIG. 5, the backlight unit 200 may have the structure in which the reflection layer 240 covers an upper surface of the first layer 210 in the non-formation area of the light sources 220. For example, the reflection layer 240 may be formed on the first layer 210 and may have a plurality of holes, into which the light sources 220 may be inserted, at a location corresponding to a formation location of the light sources 220. The light sources 220 may upwardly protrude from the holes of the reflection layer 240 and may be covered by the second layer 230.

FIG. 6 illustrates a second exemplary configuration of a backlight unit according to the embodiment of the invention. As mentioned above, the backlight unit of FIG. 6 or any other figures herein can be the backlight unit 200 of FIG. 3, a backlight unit used in any display device, or a backlight unit for any device, that needs the backlight unit, and can also be a light generating device. Structures and components identical or equivalent to those described in the first exemplary configuration of the backlight unit may be designated with the same reference numerals in the second exemplary configuration, and a further description may be briefly made or may be entirely omitted.

As shown in FIG. 6, the plurality of light sources 220 may be mounted on the first layer 210, and the second layer 230 may be disposed on the first layer 210. The reflection layer 240 may be formed between the first layer 210 and the second layer 230, more particularly, on an upper surface of the first layer 210.

The second layer 230 may include a plurality of scattering particles 231. The scattering particles 231 may scatter or refract incident light, thereby more widely diffusing light emitted from the light sources 220.

The scattering particles 231 may be formed of a material having a refractive index different from a formation material of the second layer 230 so as to scatter or refract the light emitted from the light source 220. More particularly, the scattering particles 231 may be formed of a material having a refractive index greater than silicon-based resin or acrylic resin forming the second layer 230. For example, the scattering particles 231 may be formed of polymethylmethacrylate (PMMA)/styrene copolymer (MS), polymethylmethacrylate (PMMA), polystyrene (PS), silicon, titanium dioxide (TiO₂), and silicon dioxide (SiO₂), or a combination thereof. Further, the scattering particles 231 may be formed of a material having a refractive index less than the formation material of the second layer 230. For example, the scattering particles 231 may be formed by generating bubbles in the second layer 230. Other materials may be used for the second layer 230. For example, the scattering particle 231 may be formed using various polymer materials or inorganic particles.

An optical sheet 250 may be disposed on the top of the second layer 230. The optical sheet 250 may include at least one prism sheet 251 and/or at least one diffusion sheet 252. In this case, a plurality of sheets constituting the optical sheet 250 are not separated from one another and are attached to one another. Thus, the thickness of the optical sheet 250 or the thickness of the backlight unit 200 may be reduced because of the above structure of the optical sheet 250.

A lower surface of the optical sheet 250 may closely adhere to the second layer 230, and an upper surface of the optical sheet 250 may closely adhere to the lower surface of the display panel 100, e.g., the lower polarizing plate 140.

The diffusion sheet 252 may diffuse incident light to thereby prevent light output from the second layer 230 from being partially concentrated. Hence, the diffusion sheet 252 may further uniformize the luminance of light. Further, the prism sheet 251 may focus light output from the diffusion sheet 252, thereby allowing the light to be vertically incident on the display panel 100.

In the embodiment of the invention, at least one of the prism sheet 251 and the diffusion sheet 252 constituting the optical sheet 250 may be removed. The optical sheet 250 may further include other functional layers in addition to the prism sheet 251 and the diffusion sheet 252.

The reflection layer 240 may include a plurality of holes at locations corresponding to the formation locations of the light sources 220, and the light sources 220 on the first layer 210 underlying the reflection layer 240 may be inserted into the holes. These holes may be indents in the first layer 210 or can be merely through holes defined by the reflection layer 240.

In this case, the light sources 220 are downwardly inserted into the holes of the reflection layer 240, and at least a portion of each of the light sources 220 may protrude from the upper surface of the reflection layer 240. Because the backlight unit 200 is configured using the structure in which the light sources 220 are respectively inserted into the holes of the reflection layer 240, a fixation strength between the first layer 210 and the reflection layer 240 may be further improved.

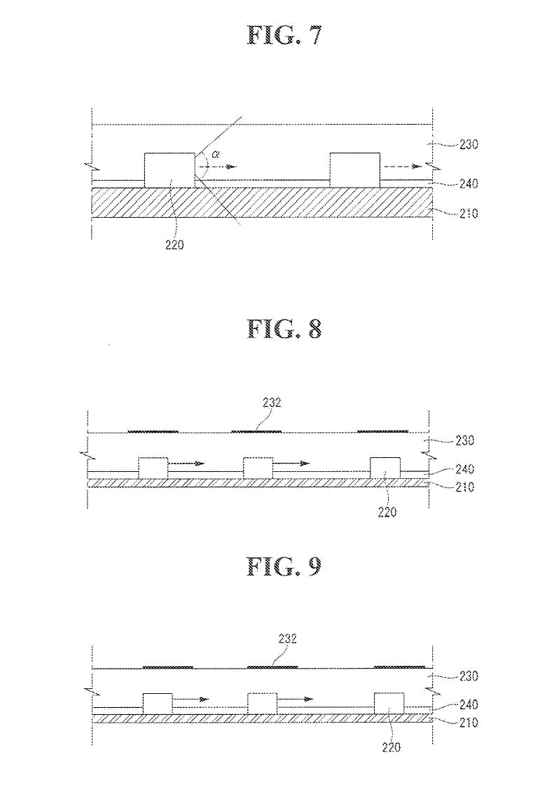

FIG. 7 illustrates a third exemplary configuration of a backlight unit according to the embodiment of the invention. Structures and components identical or equivalent to those described in the first and second exemplary configurations may be designated with the same reference numerals in the third exemplary configuration, and a further description may be briefly made or may be entirely omitted.

As shown in FIG. 7, each of the plurality of light sources 220 of the backlight unit 200 has the light emitting surface on the side thereof and may emit light in a lateral direction. e.g., a direction in which the first layer 210 or the reflection layer 240 extends.

For example, the plurality of light sources 220 may be configured using the side view type LED package. As a result, it is possible to address a problem that the light sources 220 are observed as a hot spot on the screen and to slim the backlight unit 200. Furthermore, the thin profile of the display device 1 may be achieved because of a reduction of the thickness “a” of the second layer 230.

In this case, the light sources 220 may emit light having a predetermined orientation angle of for example, 90° to 150° about a first direction x (indicated by an arrow). Hereinafter, a direction of light emitted from the light sources 220 is indicated as the first direction x.

In the embodiment of the invention, light is emitted and diffused upwardly from the light sources 220 by forming a pattern on the second layer 230, and thus the backlight unit 200 may emit light having the uniform luminance.

FIGS. 8 to 13 illustrate a fourth exemplary configuration of a backlight unit according to the embodiment of the invention. Structures and components identical or equivalent to those described in the first to third exemplary configurations may be designated with the same reference numerals in the fourth exemplary configuration, and a further description may be briefly made or may be entirely omitted.

The light sources 220 illustrated in FIGS. 8 to 13 may emit light from the side of the light sources 220 in a lateral direction in the same or similar manner as FIG. 7. Other manners may be used. For example, the light sources 220 may emit light from the top of the light sources 220, e.g., the light may be emitted in an upward direction.

As shown in FIG. 8, a pattern layer including a plurality of first patterns 232 may be formed on the top of the second layer 230 of the backlight unit 200 including the light sources 220. More specifically, the plurality of first patterns 232 of the pattern layer may be formed on the second layer 230 at locations corresponding to the formation locations of the light sources 220. For instance, for each light source 220, one of the first patterns 232 is provided.

For example, the first patterns 232 formed on the top of the second layer 230 may be a first pattern capable of reflecting at least a portion of light emitted from the light sources 220.

A luminance of the light emitted from an area adjacent to the light sources 220 may decrease by forming the first patterns 232 on the second layer 230, and thus the backlight unit 200 may emit light having the uniform luminance.

In other words, the first patterns 232 are formed on the second layer 230 at the locations corresponding to the formation locations of the light sources 220 and selectively reflect light emitted from the light sources 220, thereby reducing the luminance of light from the area adjacent to the light sources 220. The reflected light may be diffused in a lateral direction.

More specifically, the light emitted upward from the light sources 220 is diffused in the lateral direction by the first patterns 232, and at the same time is reflected downward. The light reflected from the first patterns 232 is again diffused in the lateral direction by the reflection layer 240, and at the same time is reflected upward. In other words, the first patterns 232 may reflect 100% of incident light. Alternatively, the first patterns 232 may reflect a portion of the incident light and may transmit a portion of the incident light. As above, the first patterns 232 may control the transfer of light passing through the second layer 230 and the first patterns 232. As a result, the light emitted from the light sources 220 may be widely diffused in the lateral direction and other directions as well as the upward direction, and thus the backlight unit 200 may emit the light having the uniform luminance.

The first patterns 232 include a reflection material such as metal. For example, the first patterns 232 may include metal having a reflectance of 90% or more such as aluminum, silver, and gold. For example, the first patterns 232 may be formed of a material capable of transmitting 10% or less of incident light and reflecting 90% or more of the incident light.

In this case, the first patterns 232 may be formed by depositing or coating the above-described metal. As another method, the first patterns 232 may be formed through a printing process using a reflection ink including a metal, for example, a silver ink in accordance with a previously determined pattern.

Further, the first patterns 232 may have a color having a high brightness, for example, a color close to white so as to improve a reflection effect of the first patterns 232. More specifically, the first pattern 232 may have a color having a brightness greater than the second layer 230.

The first patterns 232 may contain metal oxide. For example, the first patterns 232 may include titanium dioxide (TiO₂). More specifically, the first patterns 232 may be formed by printing a reflection ink containing titanium dioxide (TiO₂) in accordance with a previously determined pattern.

As shown in FIGS. 9 to 13, the formation of the first patterns 232 at the locations corresponding to the locations of the light sources 220 may include the case where a middle portion of the first pattern 232 coincides with a middle portion of the light source 220 corresponding to the first pattern 23 as shown in FIG. 8 and the case where the middle portion of the first pattern 232 is spaced from the middle portion of the corresponding light source 220 by a predetermined distance.

As shown in FIG. 9, the middle portion of the first pattern 232 may not coincide with the middle portion of the light source 220 corresponding to the first pattern 232.

For example, when the light emitting surface of the light source 220 faces not the upward direction but the lateral direction and therefore light is emitted from the light source 220 in the lateral direction, a luminance of light emitted from the side of the light source 220 may decrease while the light emitted from the side of the light source 220 travels through the second layer 230 in a direction indicated by an arrow of FIG. 9. Hence, light in a first area directly adjacent to the light emitting surface of the light source 220 may have a luminance greater than light in an area around the light emitting surface of the light source 220. Light in a second area adjacent to an opposite direction of the light emitting surface may have a luminance less than the light in the first area. Thus, the first pattern 232 may be formed by moving in an emission direction of light from the light source 220. In other words, the middle portion of the first pattern 232 may be formed at a location slightly deviated from the middle portion of the corresponding light source 220 toward the light emitting direction.

As shown in FIG. 10, the first pattern 232 may be formed at a location deviated further than the first pattern 232 illustrated in FIG. 9 toward the light emitting direction. In other words, a distance between the middle portion of the first pattern 232 and the middle portion of the corresponding light source 220 in FIG. 10 may be longer than a distance between the middle portion of the first pattern 232 and the middle portion of the corresponding light source 220 in FIG. 9. For example, the light emitting surface of the light source 220 may overlap or be aligned with an end portion of the first pattern 232.

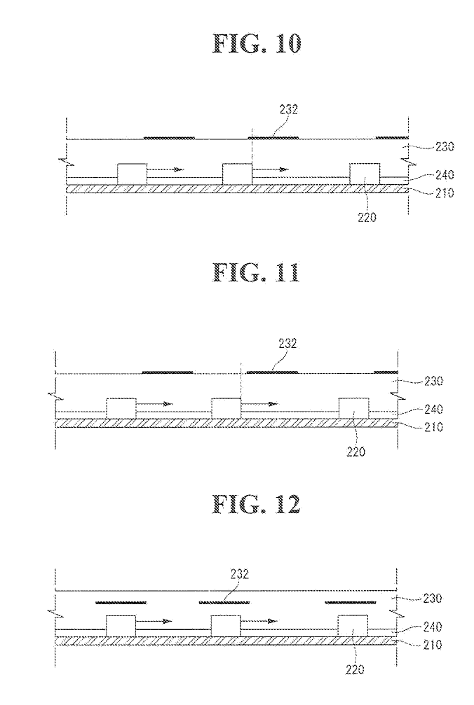

As shown in FIG. 11, the first pattern 232 may be formed at a location deviated further than the first pattern 232 illustrated in FIG. 10 toward the light emitting direction. In other words, a formation area of the first pattern 232 may not overlap a formation area of the corresponding light source 220. Hence, an end portion of the first pattern 232 may be separated from the light emitting surface of the light source 220 by a predetermined distance.

As shown in FIG. 12, the first pattern 232 may be formed inside the second layer 230. In this case, the middle portion of the first pattern 232 may be formed at a location corresponding to the light source 220. In variations, the first pattern 232 may be formed in the same manners as FIGS. 9 to 11, except that the first pattern 232 is disposed within the second layer 230.

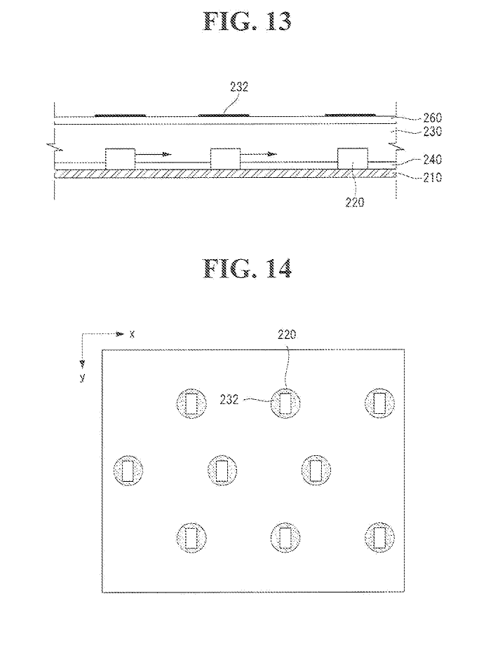

As shown in FIG. 13, the first pattern 232 may be manufactured in a sheet form. In this case, the pattern layer including the plurality of first patterns 232 may be formed on the second layer 230.

For example, after the plurality of first patterns 232 are formed on one surface of a transparent film 260 through the printing process, etc. to form the pattern layer, the pattern layer including the transparent film 260 may be stacked on the second layer 230. More specifically, a plurality of dots may be printed on the transparent film 260 to form the first patterns 232.

As a percentage of a formation area of the first pattern 232 in the second layer 230 increases, an aperture ratio decreases. Hence, the entire luminance of light which the backlight unit 200 provides to the display panel 100 may decrease. The aperture ratio may indicate the size of an area of the second layer 230 that is not occupied by the first pattern 232.

Thus, the aperture ratio of the pattern layer including the first patterns 232 may be equal to or greater than 70%, so as to prevent the degradation of the image quality resulting from an excessive reduction in the luminance of light provided to the display panel 100. That is, the percentage of the area of the second layer 230 occupied by the first pattern 232 is equal to or less 30% of the total area of the second layer 230.

FIGS. 14 to 17 are top views of the backlight unit 200 for illustrating a disposition of the first patterns 232 formed in the backlight unit 200. In these figures, although the light sources 220 may not be fully visible from the top since they may be disposed below the first patterns 232, the light sources 220 are clearly drawn merely to illustrate their locations with respect to the first patterns 232. As described above, the first patterns 232 may be formed at locations corresponding to the light sources 220; e.g., above or adjacent to the light sources.

As shown in FIG. 14, each first pattern 232 may have a circle shape or an oval shape around a formation location of the corresponding light source 220. Other shapes, colors, and/or sizes may be used for the first pattern 232. The middle portion of the first pattern 232 may be formed at a location deviated slightly from the middle portion of the corresponding light source 220 toward the light emitting direction in the same manner as FIGS. 9 to 11.

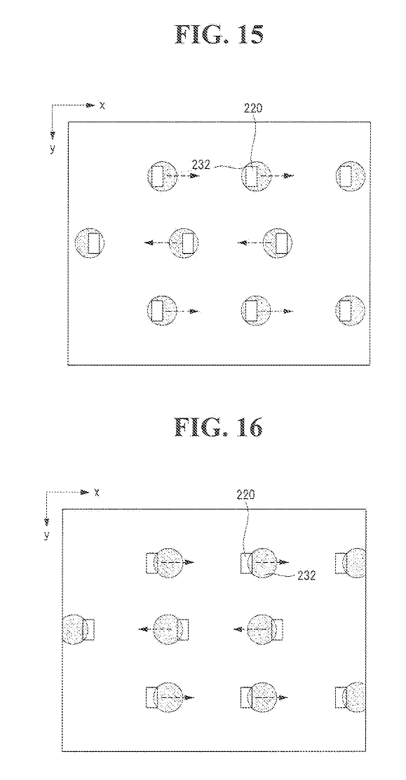

As shown in FIG. 15, the first pattern 232 may be off-centered with respect to the corresponding light sources 220 in the light emitting direction (e.g., an x-axis direction in FIG. 15). Hence, the middle portion of the first pattern 232 may be formed at a location deviated from the middle portion of the corresponding light source 220 toward the light emitting direction by a predetermined distance.

As shown in FIG. 16, the first pattern 232 may be off-centered toward the light emitting direction further than the first pattern 232 shown in FIG. 15. Hence, a portion of a formation area of the light source 220 may overlap a formation area of the first pattern 232.

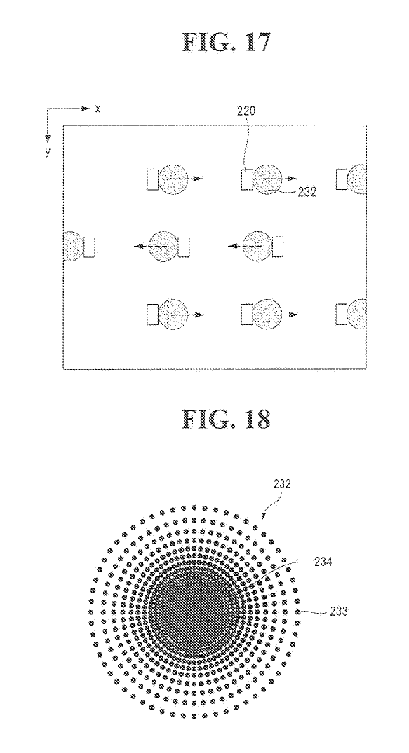

As shown in FIG. 17, the first pattern 232 may be off-centered toward the light emitting direction further than the first pattern 232 shown in FIG. 16 and thus may be positioned outside a formation area of the light source 220. Hence, a formation area of the light source 220 may not overlap a formation area of the first pattern 232.

FIGS. 18 to 21 illustrate various shapes of the first pattern 232. For instance, each of the first patterns 232 discussed above can have the configuration shown in FIG. 18, 19, 20, or 21. In FIGS. 18 to 21, the first pattern 232 may be configured by the plurality of dots or regions, and each dot or each region may contain a reflection material, for example, metal or metal oxide.

As shown in FIG. 18, the first pattern 232 may have a circle shape around the formation location of the light source 220. Other shapes such as a diamond may be used. A reflectance of the first pattern 232 may decrease as the first pattern 232 goes from a middle portion 234 of the first pattern 232 to the outside. The reflectance of the first pattern 232 may gradually decrease as the first pattern 232 goes from the middle portion 234 to the outside, because the number of dots or a reflectance of a material forming the first pattern 232 decreases as the first pattern 232 goes from the middle portion 234 to the outside.

Further, as the first pattern 232 extends from the middle portion 234 to the outwardly direction, a transmittance or an aperture ratio of the light processed by the first pattern 232 may increase. Hence, the formation location of the light source 220, more specifically, the middle portion 234 of the first pattern 232 corresponding to the middle portion of the light source 220 may have a maximum reflectance (for example, the middle portion 234 having the maximum reflectance does not transmit most of light) and a minimum transmittance or a minimum aperture ratio. As a result, the hot spot generated when light is concentrated in the formation area of the light source 220 may be more effectively prevented.

For example, an aperture ratio of the middle portion of the first pattern 232 overlapping the light source 220 may be equal to or less than 5% so as to prevent the generation of the hot spot.

In the plurality of dots 233 constituting the first pattern 232, a distance between the adjacent dots 233 may increase as the first pattern 232 goes from the middle portion 234 to the outside. Hence, as described above, as the first pattern 232 goes from the middle portion 234 to the outside, the transmittance or the aperture ratio of the first pattern 232 may increase while the reflectance of the first pattern 232 decreases.

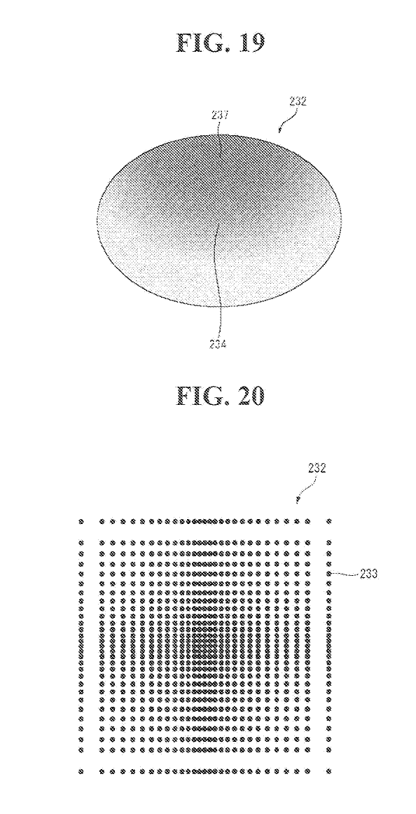

As shown in FIG. 19, the first pattern 232 may have an oval shape. The middle portion 234 of the first pattern 232 may coincide with the middle portion of the corresponding light source 220. Alternatively, the middle portion 234 of the first pattern 232 may not coincide with the middle portion of the corresponding light source 220. In other words, the middle portion 234 of the first pattern 232 may be formed at a location deviated from the middle portion of the corresponding light source 220 toward one direction (for example, a light emitting direction of the corresponding light source 220) in the same manner as FIGS. 9 to 11.

In this case, as the first pattern 232 extends from a portion 237 of the first pattern 232 corresponding to the middle portion of the light source 220 to the outwardly direction, the reflectance of the first pattern 232 may decrease or the transmittance of the first pattern 232 may increase. That is, the portion 237 of the first pattern 232 may be positioned at a location deviated from the middle portion 234 of the first pattern 232 in one direction. The portion 237 of the first pattern 232 may have a maximum reflectance or a minimum transmittance.

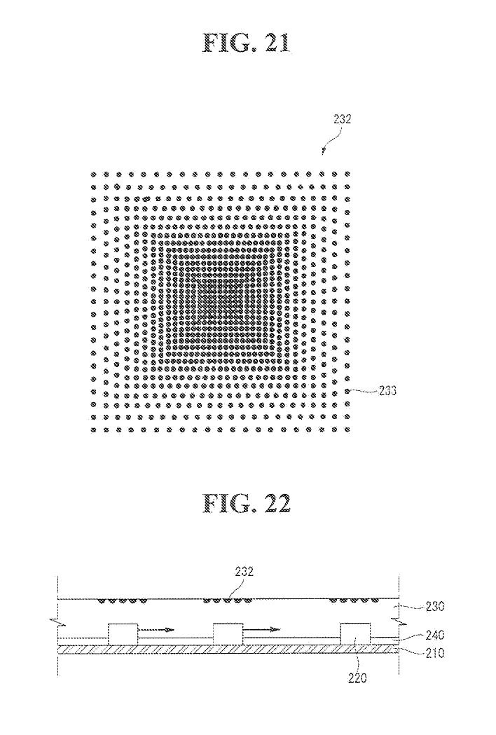

As shown in FIGS. 20 and 21, the first pattern 232 may have a rectangular shape around the formation location of the light source 220. As the first pattern 232 extends from the middle portion to the outwardly direction, a reflectance of the first pattern 232 may decrease and a transmittance or an aperture ratio may increase.

The first rectangular pattern 232 shown in FIGS. 20 and 21 may have the same characteristics as the first pattern 232 shown in FIGS. 18 and 19. For example, an aperture ratio of the middle portion of the first pattern 232 overlapping the light source 220 may be equal to or less than 5% so as to prevent the generation of the hot spot.

Further, as shown in FIGS. 20 and 21, in the plurality of dots 233 constituting the first pattern 232, a distance between the adjacent dots 233 may increase from the middle portion of the first pattern 232 to the outwardly direction.

In the embodiment of the invention, the first pattern 232 is configured to include the plurality of dots as shown in FIGS. 18 to 21. However, other configurations may be used. The first pattern 232 may have any configuration as long as the reflectance of the first pattern 232 decreases and the transmittance or the aperture ratio of the first pattern 232 increases as one moves from the middle portion of the first pattern 232 to the outwardly direction.

For example, as the first pattern 232 extends from the middle portion to the outwardly direction, a concentration of a reflection material, for example, metal or metal oxide may decrease. Hence, the reflectance of the first pattern 232 may decrease and the transmittance or the aperture ratio of the first pattern 232 may increase. As a result, the concentration of light in an area adjacent to the light source 220 may be reduced.

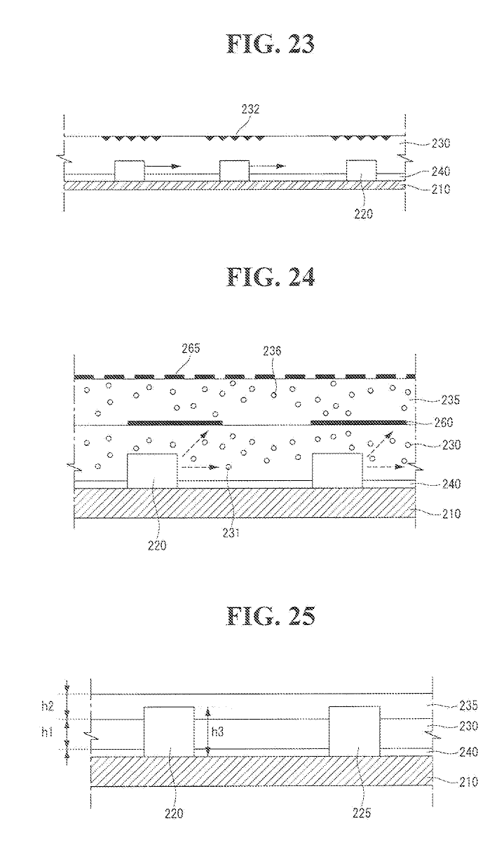

FIGS. 22 and 23 illustrate a fifth exemplary configuration of a backlight unit according to the embodiment of the invention. Structures and components identical or equivalent to those described in the first to fourth exemplary configurations may be designated with the same reference numerals in the fifth exemplary configuration, and a further description may be briefly made or may be entirely omitted.

As shown in FIG. 22, the first pattern 232 may have a convex shape protruding toward the light source 220. For example, the first pattern 232 may have a shape similar to a semicircle. A cross-sectional shape of the first pattern 232 may have a semicircle shape or an oval shape protruding toward the light source 220.

The first pattern 232 having the convex shape may reflect incident light at various angles. Hence, the first pattern 232 may uniformize the luminance of light emitted upward from the second layer 230 by diffusing more widely light emitted from the light source 220.

The first pattern 232 may include the reflection material such as metal or metal oxide as described above. For example, the first pattern 232 may be formed by forming a pattern on the top of the second layer 230 by an intaglio method and then filling the intaglio pattern with a reflection material. Alternatively, the first pattern 232 may be formed on the top of the second layer 230 by printing the reflection material on a film type sheet or attaching beads or metallic particles to the film type sheet and then pressing the film type sheet onto the second layer 230.

A cross-sectional shape of the first pattern 232 may have various shapes protruding toward the light source 220 in addition to a shape similar to the semicircle shown in FIG. 22. For example, as shown in FIG. 23, the cross-sectional shape of the first pattern 232 may have a triangular shape protruding toward the light source 220. In this case, the first pattern 232 may have a pyramid shape or a prism shape.

FIG. 24 illustrates a sixth exemplary configuration of a backlight unit according to the embodiment of the invention. Structures and components identical or equivalent to those described in the first to fifth exemplary configurations may be designated with the same reference numerals in the sixth exemplary configuration, and a further description may be briefly made or may be entirely omitted.

Referring to FIG. 24, light emitted from the light source 220 may be diffused by the second layer 230 and may be emitted upward. Further, the second layer 230 includes the plurality of scattering particles 231 to scatter or refract the upward emitted light, thereby making the luminance of the upward emitted light more uniform.

In the embodiment of the invention, a third layer 235 may be disposed on top of the second layer 230. The third layer 235 may be formed of the same material as or a different material from the second layer 230 and may improve the uniformity of the luminance of the light of the backlight unit 200 by diffusing the light emitted upward from the second layer 230.

The third layer 235 may be formed of a material having a refractive index equal to or different from a refractive index of a material forming the second layer 230. For example, when the third layer 235 is formed of a material having a refractive index greater than the second layer 230, the third layer 235 may more widely diffuse the light emitted from the second layer 230. In contrast, when the third layer 235 is formed of a material having a refractive index less than the second layer 230, a reflectance of light, which is emitted from the second layer 230 and is reflected on the bottom of the third layer 235, may be improved. Hence, the third layer 235 may allow the light emitted from the light source 220 to easily travel along the second layer 230.

The third layer 235 may also include a plurality of scattering particles 236. In this case, a density of the scattering particles 236 of the third layer 235 may be greater higher than a density of the scattering particles 231 of the second layer 230.

As described above, because the third layer 235 includes the scattering particles 236 having the density greater than the scattering particles 231 of the second layer 230, the third layer 235 may more widely diffuse the light emitted upward from the second layer 230, thereby making the luminance of the light emitted from the backlight unit 200 more uniform.

In the embodiment of the invention, the first pattern 232 explained by referring to FIGS. 7 to 19 may be formed between the second layer 230 and the third layer 235 or inside at least one of the second layer 230 and the third layer 235.

As shown in FIG. 24, another pattern layer may be formed on top of the third layer 235. The pattern layer on the third layer 235 may include a plurality of second patterns 265.

The second patterns 265 on top of the third layer 235 may be reflection patterns capable of reflecting at least a portion of light emitted from the second layer 230. Thus, the second patterns 265 may further uniformize the luminance of light emitted from the third layer 235.

For example, when the light emitted upward from the third layer 235 is concentrated in a predetermined portion and is observed as light having a high luminance on the screen, the second patterns 265 may be formed in a region corresponding to the predetermined portion of the top of the third layer 235. Hence, the second patterns 265 may uniformize the luminance of light emitted from the backlight unit 200 by reducing the luminance of the light in the predetermined portion.

The second pattern 265 may be formed of titanium dioxide (TiO₂). In this case, a portion of light emitted from the third layer 235 may be reflected downward from the second patterns 265 and a remaining portion of the light emitted from the third layer 235 may be transmitted.

As shown in FIG. 25, a thickness h1 of the second layer 230 may be less than a height h3 of the light source 220 or 225. Hence, the second layer 230 may cover a portion of a lower part of the light source 220, and the third layer 235 may cover a portion of an upper part of the light source 220.

The second layer 230 may be formed of resin having a high adhesive strength. For example, an adhesive strength of the second layer 230 may be greater than the third layer 235. Hence, the light emitting surface of the light source 220 may be strongly attached to the second layer 230, and a space between the light emitting surface of the light source 220 and the second layer 230 may not be formed.

In the embodiment of the invention, the second layer 230 may be formed of silicon-based resin having a high adhesive strength, and the third layer 235 may be formed of acrylic resin. In this case, the refractive index of the second layer 230 may be greater than the refractive index of the third layer 235, and each of the second and third layers 230 and 235 may have the refractive index of approximately 1.4 to 1.6. Further, a thickness h2 of the third layer 235 may be less than the height h3 of the light source 220.

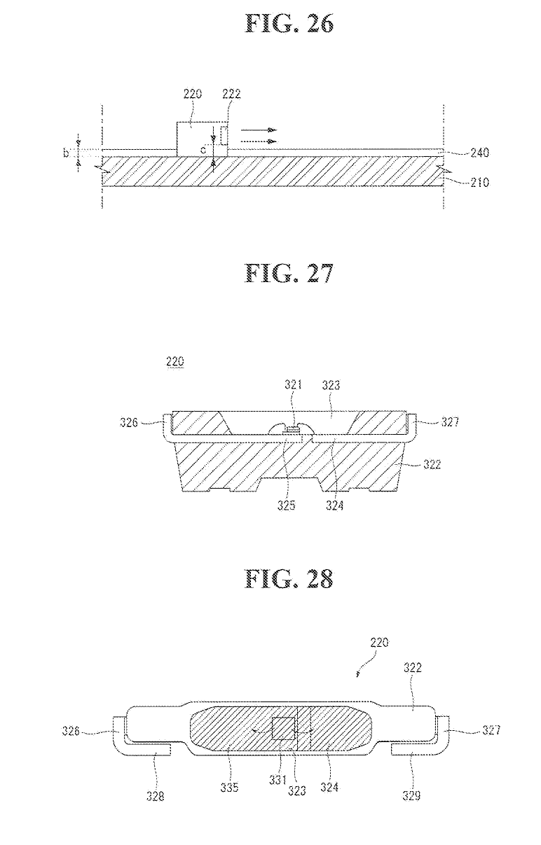

FIG. 26 illustrates a location relationship between the light source 220 and the reflection layer 240 of the backlight unit according to an embodiment of the invention.

As shown in FIG. 26, because the reflection layer 240 is disposed at the side of the light source 220, a portion of light emitted from the light source 220 toward the side of the light source 220 may be incident on the reflection layer 240 and may be lost.

The loss of light emitted from the light source 220 can decrease an amount of the light that is incident on the second layer 230 and then passes through the second layer 230. Hence, an amount of light incident on the display panel 100 from the backlight unit 200 may decrease. As a result, the luminance of the image displayed on the display device may be reduced.

Each of the light sources 220 may include a light emitting unit 222 (e.g., LED) emitting light. The light emitting unit 222 may be positioned at a location separated from the surface of the first layer 210 by a predetermined height “c”.

The thickness “b” of the reflection layer 240 may be equal to or less than the height “c” of the light emitting unit 222. Hence, the light source 220 may be positioned above the reflection layer 240.

Accordingly, the thickness “b” of the reflection layer 240 may be approximately 10 nm to 100 μm. When the thickness “b” of the reflection layer 240 is equal to or greater than 10 nm, the reflection layer 240 may have a light reflectance within a reliable range. When the thickness “b” of the reflection layer 240 is equal to or less than 100 μm, the reflection layer 240 may cover the light emitting unit 222 of the light source 220. Hence, a loss of light emitted from the light source 220 may be prevented.

Accordingly, the thickness “b” of the reflection layer 240 may be approximately 10 nm to 100 μm, so that the reflection layer 240 improves an incident efficiency of light emitted from the light source 220 and reflects most of light emitted from the light source 220.

FIGS. 27 and 28 illustrate a structure of a light source of a backlight unit according to an embodiment of the invention. More specifically, FIG. 27 illustrates the structure of the light source when viewed from the side of the light source, and FIG. 28 illustrates a structure of a head part of the light source when viewed from the front of the light source.

As shown in FIG. 27, the light source 220 may include a light emitting element 321, a mold part 322 having a cavity 323, and a plurality of lead frames 324 and 325.

In the embodiment of the invention, the light emitting element 321 may be a light emitting diode (LED) chip. The LED chip may be configured by a blue LED chip or an infrared LED chip or may be configured by at least one of a red LED chip, a green LED chip, a blue LED chip, a yellow green LED chip, and a white LED chip or a combination thereof.

Hereinafter, the embodiment of the invention will be described using a case in which the light source 220 is configured to include the LED chip 321 as the light emitting device as an example.

The LED chip 321 may be packaged in the mold part 322 constituting a body of the light source 220. For this, the cavity 323 may be formed at one side of the center of the mold part 322. The mold part 322 may be injection-molded with a resin material such as polyphtalamide (PPA) to a press (Cu/Ni/Ag substrate), and the cavity 323 of the mold part 322 may serve as a reflection cup. The shape or structure of the mold part 322 may be changed and is not limited thereto.

Each of the lead frames 324 and 325 may penetrate the mold part 322 in a long axis direction of the mold part 322. Ends 326 and 327 of the lead frames 324 and 325 may be exposed to the outside of the mold part 322. Herein, when viewed from the bottom of the cavity 323 where the LED chip 321 is disposed, a long-direction symmetrical axis of the mold part 322 is referred to as a long axis and a short-direction symmetrical axis of the mold part 322 is referred to as a short axis.

A semiconductor device such as a light receiving element and a protection element may be selectively mounted on the lead frames 324 and 325 in the cavity 323 along with the LED chip 321. For instance, the protection device such as a zener diode for protecting the LED chip 321 from electrostatic discharge (ESD) may be mounted on the lead frames 324 and 325 along with the LED chip 321.

The LED chip 321 may attach to any one lead frame (for example, the lead frame 325) positioned on the bottom of the cavity 323, and then may be bonded by wire bonding or flip chip bonding.

Further, after the LED chip 321 is connected to the lead frame 325 in the cavity 323, a resin and a phosphor that are a color conversion layer may be molded to the mounting region. The resin includes silicon or an epoxy material. The phosphor may be yellow depending on a color of light that the LED chip 321 emits. For example, when the LED chip 321 emits blue light, the yellow phosphor may convert the blue light into white light. The color conversion layer may be formed in any one form of a flat form in which the surface of the color conversion layer is molded with the same height as the top of the cavity 323, a concave lens form concaved to the top of the cavity 323, and a convex lens form protruding to the top of the cavity 323.

At least one side of the cavity 323 may be inclined, and the inclined side of the cavity 323 may serve as a reflection surface (not shown) or a reflection layer (not shown) for selectively reflecting incident light. The cavity 323 may have a polygonal exterior shape and may have other shapes other than a polygonal shape.

As shown in FIG. 28, a head part of the light source 220 corresponding to a light emitting part may include a light emitting surface actually emitting light and a non-emitting surface which is a part other than the light emitting surface and does not emit light.

More specifically, the light emitting surface of the head part 322 of the light source 220 may be formed by the mold part 322 and may be defined by the cavity 323 in which the LED chip 321 is positioned. For example, the LED chip 321 may be disposed in the cavity 323 of the mold part 322, and light emitted from the LED chip 321 may be emitted through the light emitting surface surrounded by the mold part 322. Further, the non-emitting surface of the head part of the light source 220 may be a part where the mold part 322 is formed and the light is not emitted.

Further, as shown in FIG. 28, the light emitting surface of the head part of the light source 220 may have a shape in which a transverse length is longer than a longitudinal length. Other shapes may be used for the light emitting surface of the head part. For example, the light emitting surface may have a rectangular shape.

In addition, the non-emitting surface of the light source 220 may be positioned at upper, lower, left, or right side of the light emitting surface of the head part 332 of the light source 220.

The ends 326 and 327 of the lead frames 324 and 325 may be first formed to extend to the outside of the mold part 322 and then may be secondly formed in one groove of the mold part 322. Hence, the ends 326 and 327 may be disposed in first and second lead electrodes 328 and 329. Herein, the number of such forming steps may vary.

The first and second lead electrodes 328 and 329 of the lead frames 324 and 325 may be formed to be received in grooves formed at both sides of the bottom of the mold part 322. Further, the first and second lead electrodes 328 and 329 may be formed to have a plate structure of a predetermined shape and may have a shape in which solder bonding is easy performed in surface mounting.

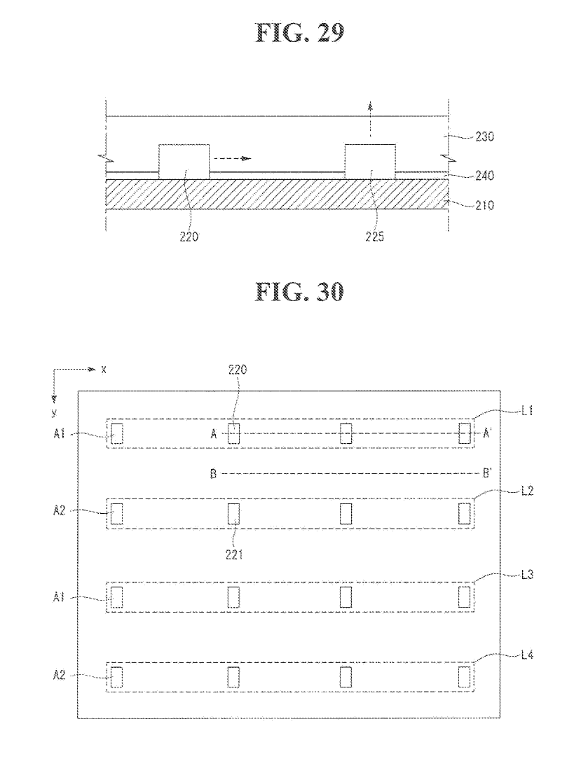

FIG. 29 illustrates a structure of the light sources of a backlight unit according to an embodiment of the invention.

As shown in FIG. 29, the first light source 220 and the second light source 225 of the plurality of light sources 220 of the backlight unit 200 may emit light in different directions.

For example, the first light source 220 may emit the light in the lateral direction. For this, the first light source 220 may be configured using the side view type LED package. The second light source 225 may emit the light in the upward direction. For this, the second light source 225 may be configured using the top view type LED package. In other words, the plurality of light sources 220 of the backlight unit 200 may be configured by combining the side view type LED packages and the top view type LED packages.

As described above, because the backlight unit 200 is configured by combining two or more light sources that emit light in different directions, an increase and a reduction in the luminance of light in a predetermined area may be prevented. As a result, the backlight unit 200 may provide light with the uniform luminance to the display panel 100.

In FIG. 29, the embodiment of the invention is described using a case where the first light source 220 emitting the light in the lateral direction and the second light source 225 emitting the light in the upward direction are disposed adjacent to each other as an example, but the invention is not limited thereto. For example, the side view type light sources may be disposed adjacent to each other or the top view type light sources may be disposed adjacent to each other.

FIGS. 30 to 34 illustrate a front shape of the backlight unit including light sources according to the exemplary embodiment of the invention. The light sources in these figures can be have any configuration discussed in any of the embodiments discussed herein.

As shown in FIG. 30, the plurality of light sources 220 and 221 of the backlight unit 200 may be divided into a plurality of arrays, for example, a first light source array A1 and a second light source array A2.

Each of the first light source array A1 and the second light source array A2 may include a plurality of light source lines each including light sources. For example, the first light source array A1 may include a plurality of light source lines L1 each including at least two light sources, and the second light source array A2 may include a plurality of light source lines L2 each including at least two light sources

The plurality of light source lines L1 of the first light source array A1 and the plurality of light source lines L2 of the second light source array A2 may be alternately disposed so as to correspond to the display area of the display panel 100.

In the embodiment of the invention, the first light source array A1 may include odd-numbered light source lines each including at least two light sources from the top of the plurality of light source lines, and the second light source array A2 may include even-numbered light source lines each including at least two light sources from the top of the plurality of light source lines.

In the embodiment of the invention, the backlight unit 200 may be configured so that a first light source line L1 of the first light source array A1 and a second light source line L2 of the second light source array A2 are disposed adjacent to each other up and down and the first light source line L1 and the second light source line L2 are alternately disposed.

Further, the light source 220 of the first light source array A1 and the light source 221 of the second light source array A2 may emit light in the same direction or in different directions.

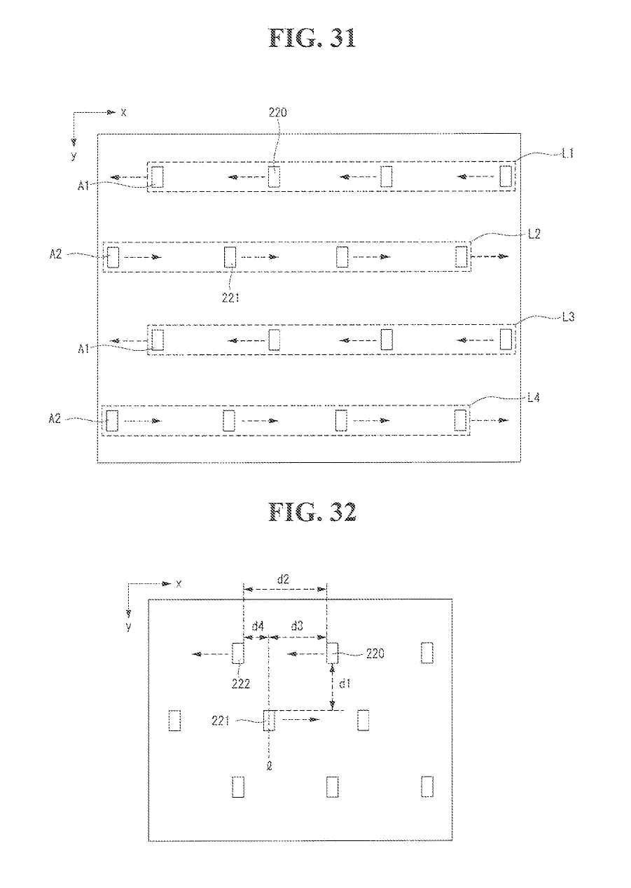

As shown in FIG. 31, the backlight unit 200 may include two or more light sources that emit light in different directions.

For instance, the light sources 220 of the first light source array A1 and the light sources 221 of the second light source array A2 may emit light in different directions. For this, a facing direction of light emitting surfaces of the light sources 220 of the first light source array A1 face may be different from a facing direction of light emitting surfaces of the light sources 221 of the second light source array A2.

More specifically, the light emitting surface of the first light source 220 of the first light source array A1 and the light emitting surface of the second light source 221 of the second light source array A2 may face in opposite directions or substantially directions. Hence, the first light source 220 of the first light source array A1 and the second light source 221 of the second light source array A2 may emit light in opposite directions or substantially directions. In this case, each of the light sources of the backlight unit 200 may emit light in the lateral direction and may be configured by using the side view-type LED package.

The plurality of light sources of the backlight unit 200 may be disposed while forming two or more lines. Two or more light sources on the same line may emit light in the same direction. For example, light sources, adjacent to right and left sides of the first light source 220 may emit light in the same direction as the first light source 220, e.g., in the opposite direction of the x-axis direction. Light sources adjacent to right and left sides of the second light source 221 may emit light in the same direction as the second light source 221, e.g., in the x-axis direction.

As described above, the light sources (for example, the first light source 220 and the second light source 221) disposed adjacent to each other in a y-axis direction may be configured so that their light emitting direction are opposite or substantially opposite to each other. Hence, the luminance of light emitted from the light sources may be prevented from being increased or reduced in a predetermined area of the backlight unit 200.

That is, because light emitted from the first light source 220 travels toward the light source adjacent to the first light source 220, a luminance of light may be reduced. As a result, the luminance of the light, which is emitted from the first light source 220, travels to an area distant from the first light source 220, and is emitted from the area in a direction of the display panel 100, may be reduced.

Accordingly, because the first light source 220 and the second light source 221 emit light in the opposite directions in the embodiment of the invention, a luminance of light emitted from the first light source 220 and the second light source 221 may be complementarily prevented from increasing in the area adjacent to the light source and from being reduced in the area distant from the light source. Hence, the luminance of light provided by the backlight unit 200 may be uniformized.

Further, the light sources of the first light source line L1 of the first light source array A1 and the light sources of the second light source line L2 of the second light source array A2 may not disposed in the straight line in a vertical direction and may be staggered in the vertical direction. As a result, the uniformity of light emitted from the backlight unit 200 may be improved. That is, the first light source 220 of the first light source array A1 and the second light source 221 of the second light source array A2 may be disposed adjacent to each other in a diagonal direction.

As shown in FIG. 32, two vertically adjacent light source lines (for example, the first and second light source lines L1 and L2) respectively included in the first and second light source arrays A1 and A2 may be separated from each other by a predetermined distance d1. In other words, the first light source 220 of the first light source array A1 and the second light source 221 of the second light source array A2 may be separated from each other by the predetermined distance d1 based on the y-axis direction perpendicular to an x-axis being a light emitting direction.

As the distance d1 between the first and second light source lines L1 and L2 increases, an area where light emitted from the first light source 220 or the second light source 221 cannot reach may be generated. Thus, the luminance of light in the non-reach area of light may be reduced. Further, as the distance d1 between the first and second light source lines L1 and L2 decreases, the light emitted from the first light source 220 and the light emitted from the second light source 221 may interfere with each other. In this case, the division driving efficiency of the light sources may be deteriorated.

Accordingly, the distance d1 between the adjacent light source lines (for example, the first and second light source lines L1 and L2) in a crossing direction of the light emitting direction may be approximately 5 mm to 22 mm, so as to uniformize the luminance of light provided by the backlight unit 200 while reducing the interference between the light sources.

Further, the third light source 222 included in the first light source line L1 of the first light source array A1 may be disposed adjacent to the first light source 220 in the light emitting direction. The first light source 220 and the third light source 222 may be separated from each other by a predetermined distance d2.

A light orientation angle θ from the light source and a light orientation angle θ′ inside the second layer 230 may satisfy the following Equation 1 in accordance with Snell's law.

$$\frac{n 1}{n 2} = \frac{sin {θ}^{′}}{sin θ} \qquad [ Equation 1 ]$$

Considering that a light emitting portion of the light source is an air layer (having a refractive index n1 of 1) and the orientation angle θ of light emitted from the light source is generally 60°, the light orientation angle θ′ inside the second layer 230 may have a value indicated in the following Equation 2 in accordance with the above Equation 1.

$$sin {θ}^{′} = \frac{sin {60}^{°}}{n 2} \qquad [ Equation 2 ]$$

Further, when the second layer 230 is formed of an acrylic resin such as polymethyl methacrylate (PMMA), the second layer 230 has a refractive index of approximately 1.5. Therefore, the light orientation angle θ′ inside the second layer 230 may be approximately 35.5° in accordance with the above Equation 2.

As described with reference to the above Equations 1 and 2, the light orientation angle θ′ of the light emitted from the light source in the second layer 230 may be less than 45°. As a result, a travelling range of light emitted from the light source in the y-axis direction may be less than a travelling range of the light emitted from the light source in the x-axis direction.

Accordingly, the distance d1 between two adjacent light sources (for example, the first and second light sources 220 and 221) in a crossing direction of the light emitting direction may be smaller than the distance d2 between two adjacent light sources (for example, the first and third light sources 220 and 222) in the light emitting direction. As a result, the luminance of the light emitted from the backlight unit 200 can be uniformized.

Considering the distance d1 between the two adjacent light sources having the above-described range, the distance d2 between two adjacent light sources (for example, the first and third light sources 220 and 222) in the light emitting direction may be approximately 9 mm to 27 mm, so as to uniformize the luminance of the light emitted from the backlight unit 200 while reducing the interference between the light sources.

As shown in FIG. 32, the second light source 221 of the second light source array A2 may be disposed between the adjacent first and third light sources 220 and 222 included in the first light source array A1.

That is, the second light source 221 may be disposed adjacent to the first light source 220 and the third light source 222 in the y-axis direction and may be disposed on a straight line l passing between the first light source 220 and the third light source 222. In this case, a distance d3 between the straight line l on which the second light source 221 is disposed and the first light source 220 may be greater than a distance d4 between the straight line l and the third light source 222.

Light emitted from the second light source 221 travels in the opposite direction to a light emitting direction of the third light source 222, and thus the luminance of light emitted toward the display panel 100 may be reduced in an area adjacent to the third light source 222.

Accordingly, in the embodiment of the invention, because the second light source 221 is disposed closer to the third light source 222 than to the first light source 220, the reduction in the luminance of light in the area adjacent to the third light source 222 may be compensated using an increase in the luminance of light in the area adjacent to the second light source 221.

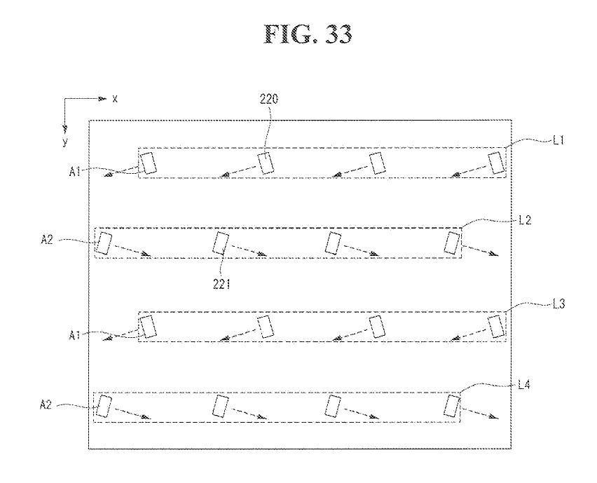

At least one of the plurality of light sources 220 of the backlight unit 200 may emit light in a horizontal direction, i.e., in a direction slightly inclined to the x-axis direction. For example, as shown in FIG. 33, facing directions of the light emitting surfaces of the light sources 220 and 221 may be upwardly or downwardly inclined to the x-axis direction by a predetermined angle.

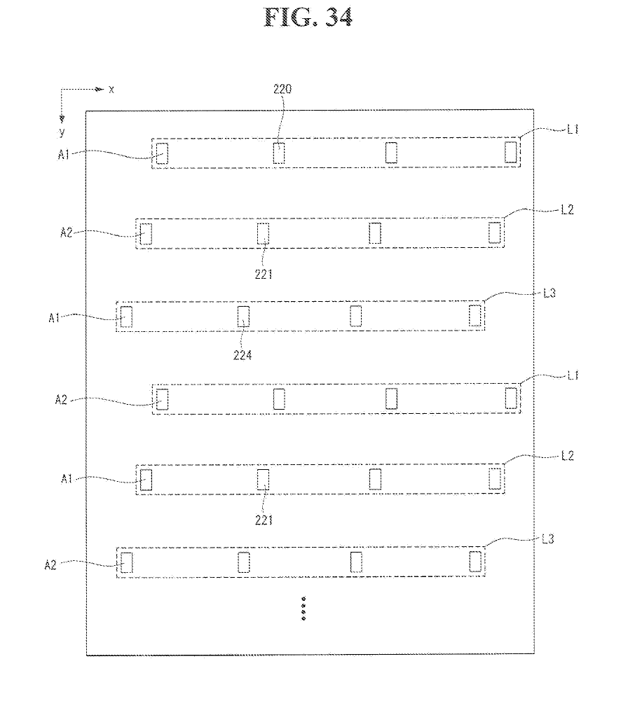

As shown in FIG. 34, the light sources 220, 221, and 224 respectively included in the light source lines L1, L2, and L3 may be staggered. For example, the light sources included in the light source lines L1, L3, and L2 of the first light source array A1 and the light sources included in the light source lines L2, L1, and L3 of the second light source array A2 may be staggered. Hence, the light source lines L1, L3, and L2 of the first light source array A1 and the light source lines L2, L1, and L3 of the second light source array A2 may be alternately disposed. The light sources 220, 221, 222, and 224 may be the same type of light sources. However, the light sources 220, 221, 222, and 224 may emit light in different directions or may be different types of light sources, if desired.

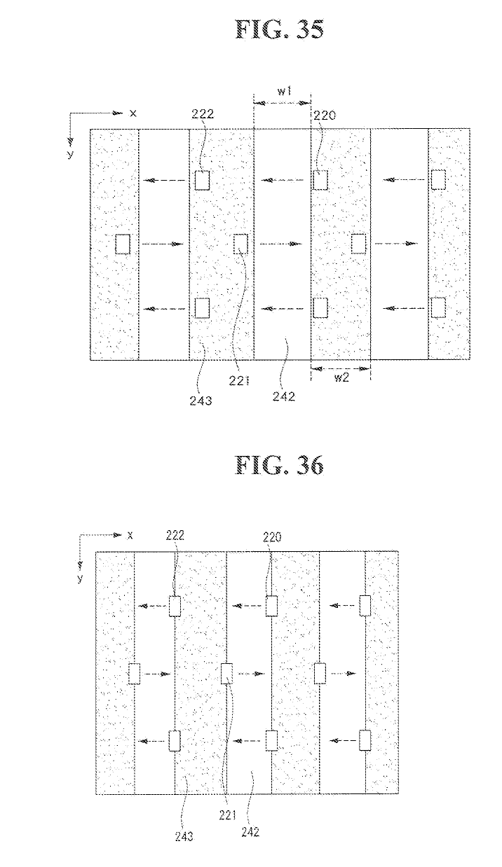

FIGS. 35 to 38 illustrate a structure of the reflection layer of the backlight unit according to an embodiment of the invention. The reflection layer in these figures or any other figures can be applied to any backlight unit of the invention.

The reflection layer 240 of the backlight unit 200 according to the embodiment of the invention may have a reflectance equal to or greater than 2. For example, the reflection layer 240 may be configured to have different reflectances depending on a position where the reflection layer 240 is formed. Namely, the reflection layer 240 may include at least two areas each having a different reflectance.

As shown in FIG. 35, the reflection layer 240 may include a first reflection layer 242 and a second reflection layer 243 that have different reflectances. The reflection layer 240 may be configured so that the first and second reflection layers 242 and 243 each having a different reflectance are alternately disposed.

For example, the reflectances of the first and second reflection layers 242 and 243 may be different from each other by configuring the first and second reflection layers 242 and 243 using reflection sheets formed of different materials, by adding a predetermined material to one of the first and second reflection layers 242 and 243 formed using the same reflection sheet, or by processing the surface of one of the first and second reflection layers 242 and 243 formed using the same reflection sheet.

In the embodiment of the invention, the first and second reflection layers 242 and 243 may be configured by one reflection sheet which is not physically separated. In this case, the first and second reflection layers 242 and 243 each having a different reflectance may be formed by forming a pattern for adjusting a reflectance of at least a portion of the reflection sheet.

That is, the reflectance of the reflection layer 240 may be adjusted by forming a pattern in at least one of a region of the reflection layer 240 corresponding to the first reflection layer 242 and a region of the reflection layer 240 corresponding to the second reflection layer 243. For example, a pattern may be formed in the region corresponding to the second reflection layer 243 in the reflection layer 240 formed using one reflection sheet, thereby adjusting the reflectance of the region corresponding to the second reflection layer 243.

More specifically, protruding patterns for diffusing light may be formed on top of the region of the reflection layer 240 corresponding to the second reflection layer 243, thereby reducing the reflectance of the region corresponding to the second reflection layer 243. In this case, a light diffusion efficiency in the region of the reflection layer 240 corresponding to the second reflection layer 243 can be improved. As a result, light emitted from the first light source 220 can be uniformly diffused to the third light source 222 adjacent to the first light source 220.

Further, surface roughnesses of the first and second reflection layers 242 and 243 may be different from each other. For example, the surface roughness of the second reflection layer 243 may be greater than the surface roughness of the first reflection layer 242, and thus the reflectance of the second reflection layer 243 may be less than the reflectance of the first reflection layer 242.

The first reflection layer 242 that is adjacent to the light sources 220, 221, and 222 based on the light emitting directions of the light sources 220, 221, and 222 may be formed using a specular reflection sheet, and the second reflection layer 243 may be formed using a diffusion reflection sheet.

Incident light is reflected from the smooth surface of the specular reflection sheet, and thus an incident angle and a reflection angle of the specular reflection sheet may be equal to each other. Therefore, the first reflection layer 242 reflects light obliquely emitted from the light sources 220, 221, and 222 at an angle equal to the incident angle and then travels the light toward the light source adjacent to the light sources 220, 221, and 222.

In the diffusion reflection sheet, incident light may be observed that the incident light is reflected and diffused at various angles because of a diffused reflection generated on a rough surface having uneven portions. Therefore, the second reflection layer 243 may allow light, which is emitted from the light sources 220, 221, and 222 and then travels, to be diffused and then emitted upward.

In the embodiment of the invention, the second reflection layer 243 formed using the diffusion reflection sheet may be formed by processing the surface of the diffusion reflection sheet to form uneven portions or by applying or adding a diffusion reflection material, for example, titanium dioxide (TiO₂) with a predetermined density.

In this case, the reflectance of the first reflection layer 242 may be greater than the reflectance of the second reflection layer 243. Therefore, as described above, the light emitted from the light sources 220, 221, and 222 may be specularly reflected from the first reflection layer 242 at the same reflection angle and may be diffusively reflected from the second reflection layer 243 to be emitted upward.

As described above, the light emitted from the light sources 220, 221, and 222 can effectively travel to the light source adjacent to the light sources 220, 221, and 222 by forming the first reflection layer 242 adjacent to the light sources 220, 221, and 222 based on the light emitting direction using a specular reflection sheet having a high reflectance. Hence, it is possible to prevent the luminance of light from being concentrated in the region adjacent to the light sources 220, 221, and 222 and to prevent the luminance of light from being reduced in the region distant from the light sources 220, 221, and 222.

As described above, the travelling light can be effectively emitted to the display panel 100 by forming the second reflection layer 243 distant from the light sources 220, 221, and 222 based on the light emitting direction using a diffusion reflection sheet having a relatively low reflectance. Hence, because a reduction in the luminance of light is compensated while allowing the light emitted from the light sources 220, 221, and 222 to travel to the adjacent light source, a reduction in the luminance of light in the region distant from the light sources 220, 221, and 222 can be prevented.

The specular reflection sheet for forming the first reflection layer 242 specularly reflects the light emitted from the light sources 220, 221, and 222 and allows the specular reflected light to travel to the adjacent light source. At the same time, the specular reflection sheet upward reflects or scatters a portion of the emitted light to emit the light to the display panel 100.

The diffusion reflection sheet for forming the second reflection layer 243 may be formed by processing the surface of a sheet formed of the same material as the specular reflection sheet or forming a plurality of protruding patterns on the sheet surface.

In the embodiment of the invention, the luminance of light in the region adjacent to the light sources 220, 221, and 222 and the luminance of light in the region distant from the light sources 220, 221, and 222 may be similarly adjusted. Therefore, the entire region of the backlight unit 200 can provide the light having the uniform luminance to the display panel 100.

A width w1 of the first reflection layer 242 adjacent to the light sources 220, 221, and 222 based on the light emitting direction may be set to be greater than a width w2 of the second reflection layer 243, so that the light emitted from the light sources 220, 221, and 222 travels to a formation area of the adjacent light source. However, the width w1 of the first reflection layer 242 may be equal to or less than the width w2 of the second reflection layer 243. In this case, the reflectance of the first reflection layer 242 and the reflectance of the second reflection layer 243 may be adjusted so as to achieve the above-described effect.

As the width w1 of the first reflection layer 242 decreases, a travelling performance of light emitted from the light sources 220, 221, and 222 may be deteriorated. As a result, the luminance of light in the region distant from the light sources 220, 221, and 222 may be reduced. Further, when the width w1 of the first reflection layer 242 is much greater than the width w2 of the second reflection layer 243, the light may be concentrated in the region distant from the light sources 220, 221, and 222. For example, the luminance of light in a middle region between the two adjacent light sources 220 and 222 may be less than that in the region distant from the light sources 220, 221, and 222.

Accordingly, the width w1 of the first reflection layer 242 may be 1.1 to 1.6 times the width w2 of the second reflection layer 243, so that the entire area of the backlight unit 200 can provide the light having the uniform luminance to the display panel 100 by upward emitting the light emitted from the light sources 220, 221, and 222 through the effective travel of the light emitted from the light sources 220, 221, and 222 to the formation area of the adjacent light source.

As shown in FIG. 35, the first light source 220 and the second light source 221 that are disposed adjacent to each other in the y-axis direction may be disposed at a position (i.e. outside a formation area of the first reflection layer 242) not overlapping the first reflection layer 242. Further, the third light source 222 adjacent to the first light source 220 in the x-axis direction and the second light source 221 may be disposed inside a formation area of the second reflection layer 243.

For example, holes into which the second light source 221 and the third light source 222 may be inserted may be formed in the second reflection layer 243. Hence, the second and third light sources 221 and 222 mounted on the first layer 210 underlying the second reflection layer 243 may protrude upward through the holes of the second reflection layer 243 and emit the light in the lateral direction.

Since the location of the light sources 220, 221, and 222 shown in FIG. 35 is only one example out of various locations, a location relationship between the light sources 220, 221, and 222 and the first and second reflection layers 242 and 243 may vary in the embodiment of the invention.

As shown in FIG. 36, the light sources 220, 221, and 222 may be formed at a location overlapping boundary portions between the first and second reflection layers 242 and 243.

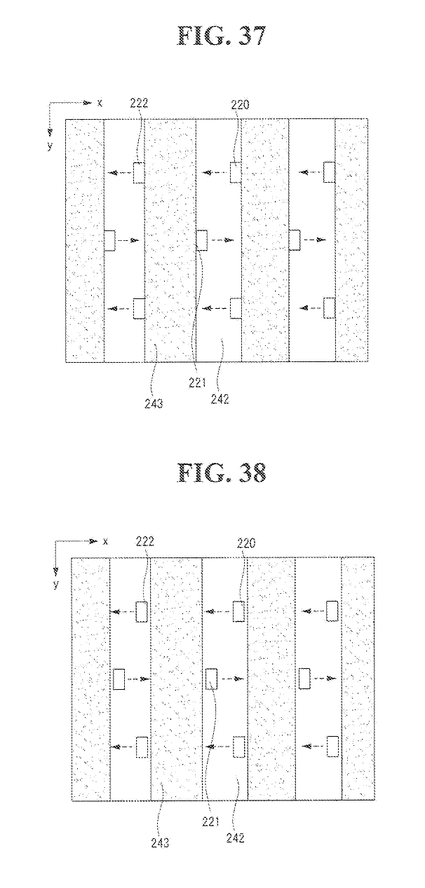

As shown in FIG. 37, the light sources 220, 221, and 222 may be positioned inside the formation area of the first reflection layers 242.

As shown in FIG. 38, the light sources 220, 221, and 222 may be positioned inside the formation area of the first reflection layers 242 at locations separated from the boundary portions between the first and second reflection layers 242 and 243 by a predetermined distance.

In the embodiment of the invention, a gradation area in which a reflectance gradually increases or decreases may be formed in the boundary portion between the first and second reflection layers 242 and 243 each having the different reflectance. For example, the reflectance of the gradation area may gradually decrease as the gradation area goes from one side thereof adjacent to the first reflection layer 242 to the other side thereof adjacent to the second reflection layer 243.

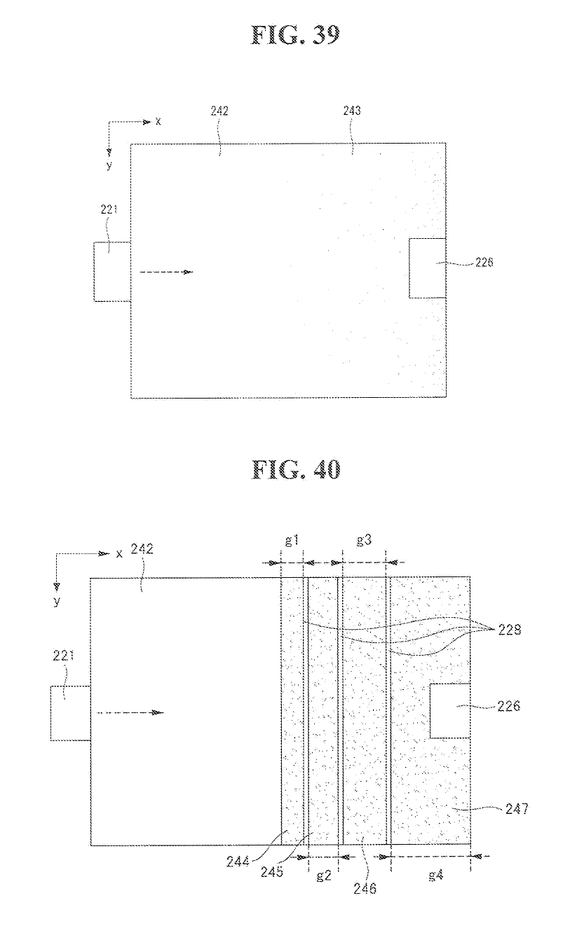

FIG. 39 illustrates another structure of the reflection layer of a backlight unit according to the embodiment of the invention.

As shown in FIG. 39, the reflectance of the second reflection layer 243 may gradually increase or decrease depending on a location of the second reflection layer 243.

In the embodiment of the invention, the reflectance of the second reflection layer 243 may gradually decrease toward an emitting direction (i.e., the x-axis direction) of light provided by the light source 221. For example, the second reflection layer 243 has a maximum reflectance (for example, a reflectance similar to the reflectance of the first reflection layer 242) in the boundary portion between the first and second reflection layers 242 and 243. Further, the reflectance of the second reflection layer 243 may gradually decrease as the second reflection layer 243 is separated from the first reflection layer 242 and is close to a light source 226 adjacent to the light source 221.

As described above, because the reflectance of the second reflection layer 243 may gradually change in the boundary portion between the first and second reflection layers 242 and 243 or around the boundary portion, the luminance difference resulting from a rapid change in the reflectance of the second reflection layer 243 in the boundary portion may be reduced.

As described above, the second reflection layer 243 may be formed using the diffusion reflection sheet. In this case, a diffusion reflection material may be used in the second reflection layer 243. Therefore, the reflectance of the second reflection layer 243 may gradually decrease or increase depending on the location of the second reflection layer 243 by gradually increasing or reducing a concentration of the diffusion reflection material used in the second reflection layer 243.

For example, as shown in FIG. 39, a concentration of titanium dioxide (TiO₂) being the diffusion reflection material used in the second reflection layer 243 may gradually increase based on the emitting direction (i.e., the x-axis direction) of the light provided by the light source 221. Hence, the reflectance of the second reflection layer 243 may gradually decrease.

FIG. 40 illustrates another structure of the reflection layer of a backlight unit according to the embodiment of the invention.

As shown in FIG. 40, the second reflection layer 243 may include a first reflection part 244 and a second reflection part 248 each having a different reflectance. A plurality of first reflection parts 244, 245, 246, and 247 and a plurality of second reflection parts 248 may be alternately disposed.

In this case, widths g1, g2, g3, and g4 of the first reflection parts 244, 245, 246, and 247 of the second reflection layer 243 may gradually increase based on the emitting direction (i.e., the x-axis direction) of the light provided by the light source 221.

Reflectances of the first reflection parts 244, 245, 246, and 247 may be less than a reflectance of the second reflection part 248, and the reflectance of the second reflection part 248 may be equal to the reflectance of the first reflection layer 242. For this, the first reflection layer 242 and the second reflection part 248 of the second reflection layer 243 may be formed using the specular reflection sheet, and the first reflection parts 244, 245, 246, and 247 of the second reflection layer 243 may be formed using the diffusion reflection sheet. Therefore, an average reflectance of the second reflection layer 243 may be less than the reflectance of the first reflection layer 242. As a result, the entire area of the backlight unit 200 may provide the light having the uniform luminance to the display panel 100.

As shown in FIG. 40, when the widths g1, g2, g3, and g4 of the first reflection parts 244, 245, 246, and 247 respectively have gradually increasing values in the order named, e.g., in the order in which the first reflection parts 244, 245, 246, and 247 are separated from the light source 221 toward the light emitting direction (i.e., the x-axis direction), the reflectance of the second reflection layer 243 may gradually decrease. As a result, the reflectance of the second reflection layer 243 may gradually change in the boundary portion between the first and second reflection layers 242 and 243 or around the boundary portion, and thus the luminance difference resulting from a rapid change in the reflectance of the second reflection layer 243 in the boundary portion may be reduced.

In the above description, the embodiment of the invention has been described using the case in which the first reflection layer 242 has the uniform reflectance and the reflectance of the second reflection layer 243 varies depending on its location with reference to FIGS. 35 to 40, but the embodiment of the invention is not limited thereto.

For example, the second reflection layer 243 may have the uniform reflectance, and the reflectance of the first reflection layer 242 may vary depending on its location. Hence, the reflectance of the first reflection layer 242 may gradually change in the boundary portion between the first and second reflection layers 242 and 243. Further, the reflectance of each of the first and second reflection layers 242 and 243 may vary depending on their location.

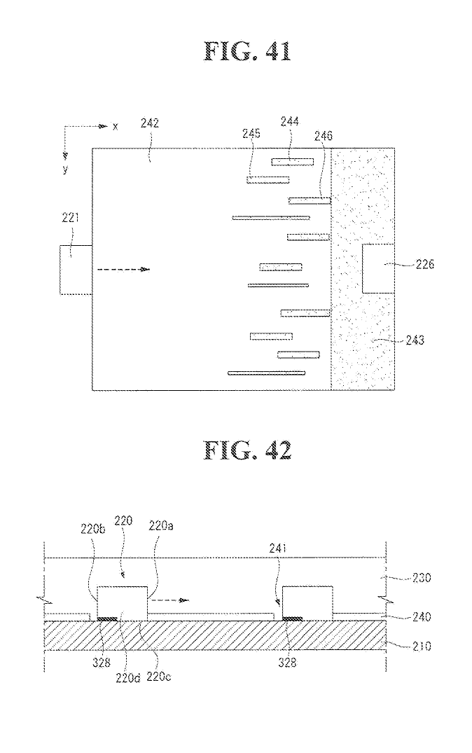

FIG. 41 illustrates another structure of the reflection layer of a backlight unit according to the embodiment of the invention.

As shown in FIG. 41, a plurality of reflection parts 244, 245, and 246 may be formed in a portion adjacent to the second reflection layer 243 in a formation area of the first reflection layer 242. The reflection parts 244, 245, and 246 may extend toward the emitting direction (i.e., the x-axis direction) of the light provided by the light source 221. Sizes, shapes, reflectances, formation materials of the reflection parts 244, 245, and 246 may be different from one another.

The reflectances of the reflection parts 244, 245, and 246 may be less than the reflectance of the first reflection layer 242 and may be equal to the reflectance of the Second reflection layer 243. For example, the reflection parts 244, 245, and 246 and the second reflection layer 243 may be formed using the diffusion reflection sheet.

Since the location of the light sources 221 and 226 shown in FIGS. 39 to 41 is only one example out of various locations, the location of the light sources 221 and 226 may vary in the embodiment of the invention with reference to FIGS. 35 to 38.

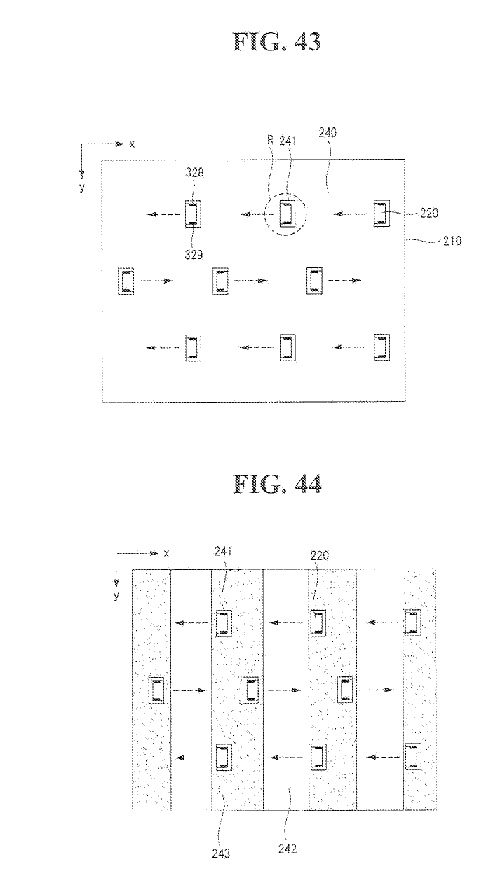

FIGS. 42 and 43 illustrate a seventh exemplary configuration of a backlight unit according to the exemplary embodiment of the invention. FIGS. 44 to 47 illustrate a structure of a reflection layer of the backlight unit according to the seventh exemplary configuration. FIGS. 48 to 57 may be considered enlarged diagrams of an area R shown in FIG. 43. In these figures, the arrows indicate a general light emitting direction of the light source, e.g., a general direction in which the light from a light emitting surface of the light source is emitted, but as understood by one skilled in the art, the light from the light source may emit not necessarily in a single line but through an area. The backlight unit or light sources of these figures can additional include any one or more features (e.g., the pattern 232, etc.) provided in the above embodiments. Further, the light sources in these figure can include the configurations of the light sources discussed in the above embodiments. FIGS. 43 to 56A show top plan views of backlight units and/or light source device; however, the lead electrodes (e.g., 328, 329, etc.) are generally not visible from the top, but are illustrated in these figures to provide relations between various components therein. Further, although the light sources (e.g., 220) have a more rectangular shape, they may have a different shape such that the side(s) of the light source are curved or integrated or may form varying angles (e.g., an angle formed by two adjacent sides may be greater than or less than a right angle). For instance, the light source 220 may have an oval or more round shape than a rectangular shape as shown in FIG. 42, and/or a light emitting surface 220 may be round (concave or convex shape). Also, the light emitting surface 220 may have one or more lenses for an enhanced propagation of light. Structures and components identical or equivalent to those described in the first to sixth exemplary configurations may be designated with the same reference numerals in the seventh exemplary configuration, and a further description may be briefly made or may be entirely omitted.

As shown in FIGS. 42 and 43, the backlight unit (e.g., backlight unit 200) according to the seventh exemplary configuration may include the first layer 210, the plurality of light sources 220, the second layer 230, and the reflection layer 240.

More specifically, the plurality of light sources 220 each having a light emitting surface may be positioned on the first layer 210. The second layer 230 may be positioned on the entire surface of the first layer 210 and may cover at least a portion of each of the plurality of light sources 220 on the first layer 210. Alternatively, the second layer 230 may cover the entire surface of each of the plurality of light sources 220 on the first layer 210, e.g., the second layer 230 may encapsulate the light sources 220 on the first layer 210. The reflection layer 240 may be positioned between the first layer 210 and the second layer 230 to reflect light emitted from the light source 220.

The plurality of light sources 220 on the first layer 210 may be configured so that the light sources 220 emitting light in one direction and the light sources 220 emitting light in another direction may be alternately disposed (e.g., in different lines).

The reflection layer 240 may include a plurality of holes 241. These holes allow predefined gaps to be provided between the surface of the reflection layer and the outer surface of the light source 220 so as to improve the performance of the backlight unit. Because the plurality of light sources 220 and the reflection layer 240 are positioned on the first layer 210, the plurality of light sources 220 and the reflection layer 240 may be positioned on the same plane.

Because the plurality of holes 241 of the reflection layer 240 are positioned on the first layer 210 on which the plurality of light sources 220 and the reflection layer 240 are positioned, the plurality of holes 241 may allow the light sources 220 to protrude from an upper part of the reflection layer 240. In other words, because a height of each light source 220 may be greater than a height of the reflection layer 240, light emitted from the light sources 220 may be reflected from the reflection layer 240 and may be widely diffused.

In the embodiment of the invention, the reflection layer 240 may be separated from one surface of at least one of the plurality of light sources 220.

Each of the light sources 220 may have a light emitting surface 220a emitting light, a back surface 220b opposite the light emitting surface 220a, a bottom surface 220c opposite the first layer 210, and a side surface 220d preferably perpendicular to the light emitting surface 220a and the bottom surface 220c. The first and second lead electrodes 328 and 329 illustrated in FIG. 28 may be positioned on the bottom surface 220c of each light source 220.

More specifically, as shown in FIGS. 42 and 43, side surfaces of the first and second lead electrodes 328 and 329 on the bottom surface 220c of the light source 220 may be positioned on the same line as the back surface 2206 of the light source 220. An inner surface of the hole 241 of the reflection layer 240 may be positioned to be separated from the back surface 220b and the side surface 220d of the light source 220 on which the first and second lead electrodes 328 and 329 are positioned. Thus, a generation of a circuit short which may result from a contact between the reflection layer 240 formed of a conductive material and the first and second lead electrodes 328 and 329 may be prevented.

As shown in FIGS. 44 to 47, the reflection layer 240 of the backlight unit 200 according to the seventh exemplary configuration may include a first reflection layer 242 and a second reflection layer 243 each having a different reflectance in the same manner as FIGS. 35 to 38. However, the reflection layer of the backlight unit of FIGS. 42-58 may have the configurations of the reflection layer discussed in any other figures/embodiments. The reflection layer 240 may be configured so that the first and second reflection layers 242 and 243 having the different reflectances are alternately disposed.

As shown in FIG. 44, the light sources 220 positioned adjacent to one another in the x-axis and y-axis directions may be positioned in non-overlapping areas (i.e., formation areas of the second reflection layers 243) between the light sources 220 and the first reflection layers 242. For example, each second reflection layer 243 may have the plurality of holes 241 into which the light sources 220 are inserted. At least one inner surface of each hole 241 may be separated from at least one surface of each light source 220 so that certain gaps between the side(s) of the light sources and the side(s) of the reflection layer are provided.

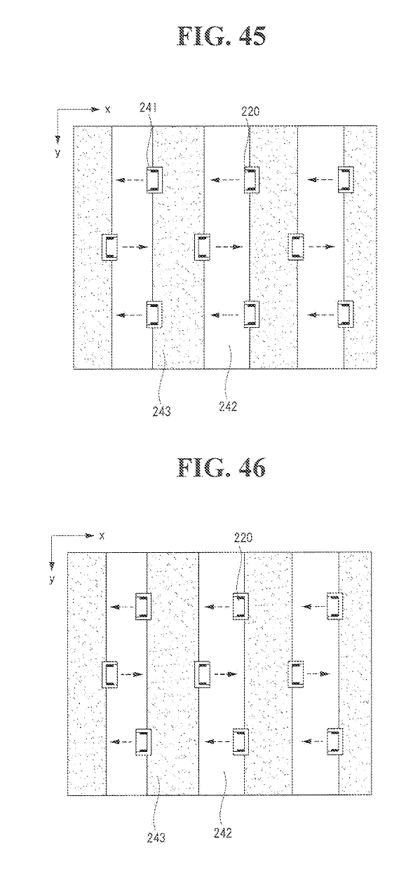

As shown in FIG. 45, the light sources 220 may be positioned at locations overlapping boundary portions between the first and second reflection layers 242 and 243. In this case, at least one inner surface of each hole 241 defined by the reflection layer 240 may be separated from at least one surface of each light source 220 so as form predefined gaps therebetween.

As shown in FIG. 46, the light sources 220 may be positioned in a formation area of the first reflection layers 242. In this case, at least one inner surface of each hole 241 may be separated from at least one surface of each light source 220.

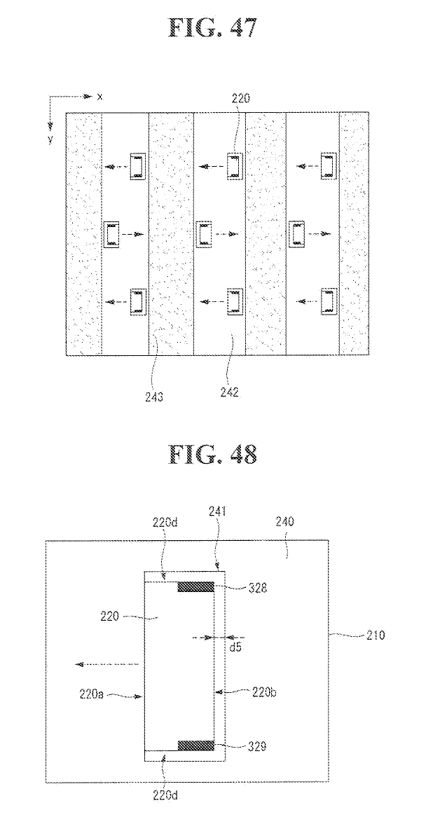

As shown in FIG. 47, the light sources 220 may be positioned in the formation area of the first reflection layers 242 at locations separated from the boundary portions between the first and second reflection layers 242 and 243 by a predetermined distance. In this case, at least one inner surface of each hole 241 may be separated from at least one surface of each light source 220.

FIGS. 44 to 47 illustrate that the first and second lead electrodes of the light sources 220 are positioned at one side of each light source 220. As variations, the first and second lead electrodes may be positioned at various locations. A relationship between the holes 241 of the reflective layer 240 and on a location of the first and second lead electrodes of the light sources 220 is below described in detail.

As shown in FIG. 48 enlarging an area R shown in FIG. 43, the light source 220 may be positioned on the first layer 210, and the reflection layer 240 may be formed on the same plane as the light source 220 on the first layer 210 and may have the hole 241 for protruding the light source 220. The hole 241 of the reflection layer 240 may be positioned to surround the light source 220, and a portion of an inner surface of the hole 241 may be separated from at least one (outer) surface of the light source 220 so that a predetermined gap or space is formed therebetween, e.g., for avoiding short circuits.

As described above, the light source 220 may have the light emitting surface 220a emitting light, the back surface 220b opposite the light emitting surface 220a, and the side surface 220d generally perpendicular to the light emitting surface 220a and the bottom surface 220e, but may not have all these surfaces. The first and second lead electrodes 328 and 329 may be positioned on or near the bottom surface 220c of the light source 220, but can be positioned at any other locations.

As shown in FIG. 48, one side surface of each of the first and second lead electrodes 328 and 329 of the light source 220 may be positioned on the same line as the back surface 220b and the side surface 220d of the light source 220.

The inner surface of the hole 241 of the reflection layer 240 may be positioned to be separated from the back surface 220b and the side surface 220d of the light source 220 on which the first and second lead electrodes 328 and 329 are positioned. Further, the inner surface of the hole 241 of the reflection layer 240 may contact the light emitting surface 220a of the light source 220 on which the first and second lead electrodes 328 and 329 are not positioned.

When the reflection layer 240 formed of, e.g., metal or metal oxide is physically or electrically separated from the first and second lead electrodes 328 and 329 of the light source 220, an electric current does not flow between the reflection layer 240 and the first and second lead electrodes 328 and 329. Hence, a malfunction (e.g., short circuit) of the light source 220 is prevented. Accordingly, because the inner surface of the hole 241 of the reflection layer 240 is positioned to be separated from the back surface 220b and the side surface 220d of the light source 220 in the embodiment of the invention, a defect such as the malfunction of the light source 220 is prevented.

A separated distance (gap distance or gap length) d5 between the light source 220 and the inner surface of the hole 241 of the reflection layer 240 may be uniform, and may be from 0.1 mm to 1 mm. When the separated distance d5 is equal to or greater than 0.1 mm, an electric current may not flow between the first and second lead electrodes 328 and 329 on one surface of the light source 220 and the reflection layer 240. Hence, the malfunction of the light source 220 may be prevented. Further, when the separated distance d5 is equal to or less than 1 mm (but equal to or greater than 0.1 mm), a reduction of a light reflection effect may be prevented. More specifically, light emitted from other light source 220 positioned in a direction of the back surface 220b of the light source 220 has to be reflected from the reflection layer 240. However, because the reflection layer 240 does not exist in a space (corresponding to the separated distance d5) between the light source 220 and the inner surface of the hole 241 of the reflection layer 240, a reflection effect of the light emitted from the other light source 220 may be reduced. However, in the embodiment of the invention, the reduction of the light reflection effect may be prevented because the distance d5 of the gap has been properly predefined to be equal to or less than 1 mm.

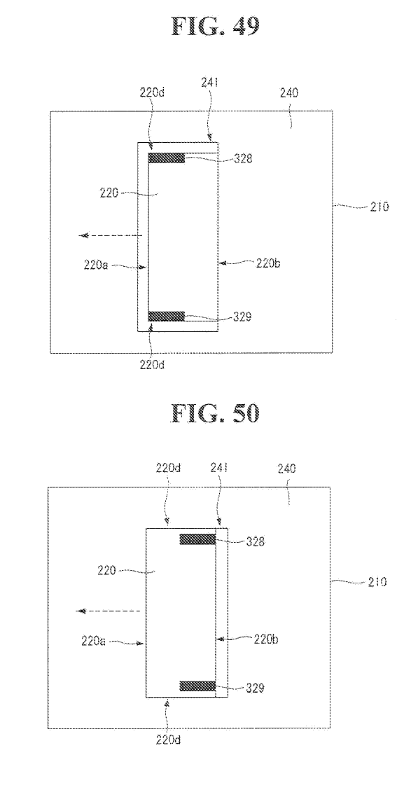

As shown in FIG. 49, the first and second lead electrodes 328 and 329 of the light source 220 may be positioned on or near the bottom surface of the light source 220, and one side surface of each of the first and second lead electrodes 328 and 329 of the light source 220 may be positioned on the same line as the light emitting surface 220a and the side surface 220d of the light source 220. The inner surface of the hole 241 of the reflection layer 240 may be positioned to be separated from the light emitting surface 220a and the side surface 220d of the light source 220 on which the first and second lead electrodes 328 and 329 are positioned. Further, the inner surface of the hole 241 of the reflection layer 240 may contact the back surface 220b of the light source 220 on which the first and second lead electrodes 328 and 329 are not positioned. For instance, the light sources 220 are positioned within the holes 241 such that the predefined gaps (having a distance such as d5 of FIG. 48) are formed at three sides of the light source 220 between the surfaces of the reflection layer 240 and the light emitting surface 220a and two side surfaces 220d of the light source 220.

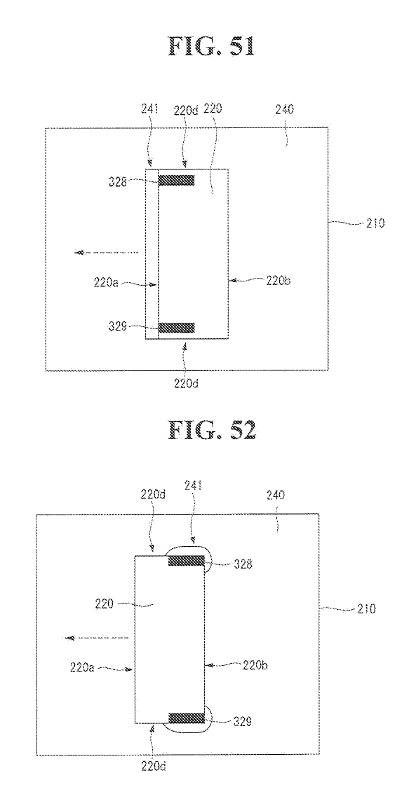

As shown in FIG. 50, the first and second lead electrodes 328 and 329 of the light source 220 may be positioned on or near the bottom surface of the light source 220, and one side surface of each of the first and second lead electrodes 328 and 329 of the light source 220 may be positioned on the same line as the back surface 220b of the light source 220. The inner surface of the hole 241 of the reflection layer 240 may be positioned to be separated from the back surface 220b of the light source 220 on which the first and second lead electrodes 328 and 329 are positioned, by a predefined distance (e.g., d5). Further, the inner surface of the hole 241 of the reflection layer 240 may contact the light emitting surface 220a and the side surface 220d of the light source 220 on which the first and second lead electrodes 328 and 329 are not positioned.

As shown in FIG. 51, the first and second lead electrodes 328 and 329 of the light source 220 may be positioned on or near the bottom surface of the light source 220, and one side surface of each of the first and second lead electrodes 328 and 329 of the light source 220 may be positioned on the same line as the light emitting surface 220a of the light source 220. The inner surface of the hole 241 of the reflection layer 240 may be positioned to be separated from the light emitting surface 220a of the light source 220 on which the first and second lead electrodes 328 and 329 are positioned by a predefined distance (e.g., d5). Further, the inner surface of the hole 241 of the reflection layer 240 may contact the back surface 220b and the side surface 220d of the light source 220 on which the first and second lead electrodes 328 and 329 are not positioned.

As shown in FIG. 52, the first and second lead electrodes 328 and 329 of the light source 220 may be positioned on or near the bottom surface of the light source 220, and one side surface of each of the first and second lead electrodes 328 and 329 of the light source 220 may be positioned on the same line as the back surface 220b and the side surface 220d of the light source 220.

Unlike the above description, the inner surface of the hole 241 of the reflection layer 240 may be positioned to be separated from a portion of each of the back surface 220b and the side surface 220d of the light source 220 on which the first and second lead electrodes 328 and 329 are positioned. In other words, the inner surface of the hole 241 of the reflection layer 240 may be separated from the light source 220 in only an area in which the first and second lead electrodes 328 and 329 are positioned.

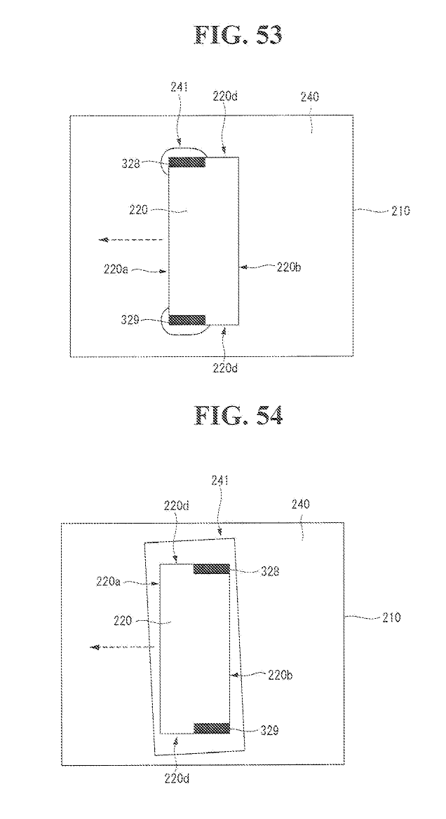

As shown in FIG. 53, one side surface of each of the first and second lead electrodes 328 and 329 of the light source 220 may be positioned on the same line as the light emitting surface 220a and the side surface 220d of the light source 220. The inner surface of the hole 241 of the reflection layer 240 may be positioned to be separated from a portion of each of the light emitting surface 220a and the side surface 220d of the light source 220 on which the first and second lead electrodes 328 and 329 are positioned. In other words, the inner surface of the hole 241 of the reflection layer 240 may be separated from the light source 220 in only an area in which the first and second lead electrodes 328 and 329 are positioned.

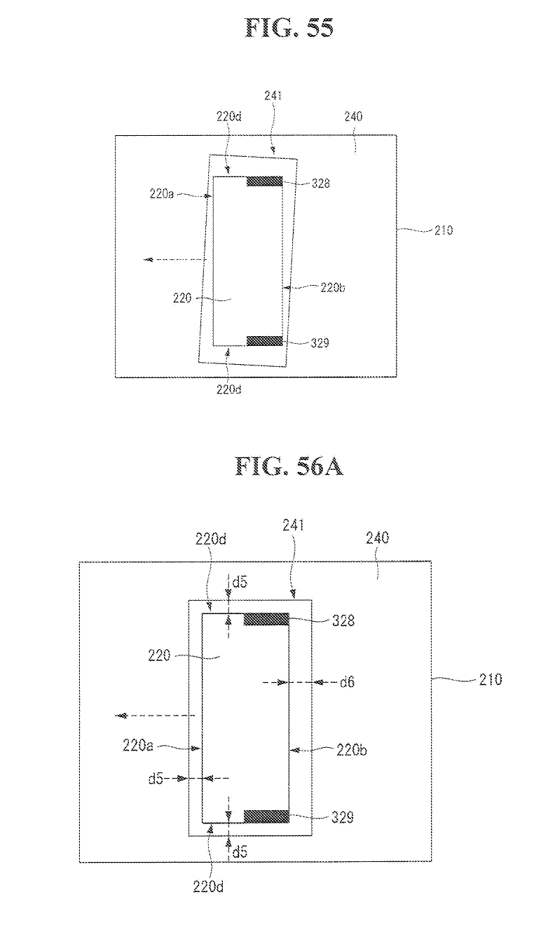

As shown in FIGS. 54 and 55, the inner surface of the hole 241 of the reflection layer 240 may be positioned to be separated from all the surfaces, e.g., the light emitting surface 220a, the back surface 220b, and the side surface 220d of the light source 220, by one or more predefined distances (e.g., d5).

In some examples above, the rectangular hole 241 of the reflection layer 240 has been described in the embodiment of the invention. Other shapes may be used for the hole 241. For example, a polygon having sides equal to or greater than three, a circle, an oval, etc. may be used.

As described above, the backlight unit according to the seventh exemplary configuration can prevent the malfunction of the light sources and the reflection effect of light by forming predefined gap(s) between the surface(s) of the reflection layer and the outer surfaces of the light source or the lead electrodes of the light source.

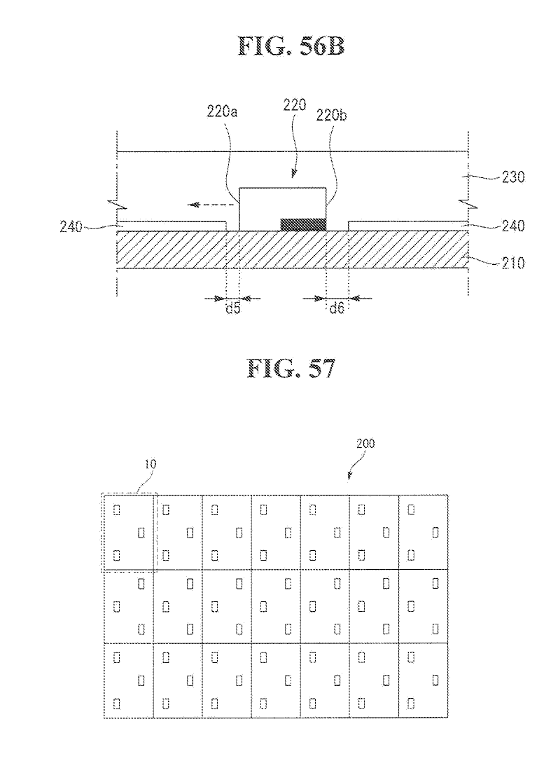

FIGS. 56A and 56B are generally top and side views and show another example of a backlight unit according to an embodiment of the invention. As shown in FIGS. 56A and 56B, at least one light source 220 of the backlight unit may be disposed within a hole 241 defined by the reflection layer 240 formed on the first layer 210, where the second layer 230 encapsulates the light source 220. The light source 220 is positioned in the hole 241 such that predefined varying gaps are provided between the surface(s) of the reflection layer 240 and the outer surfaces of the light source 220. For instance, a first predefined gap having a set distance such as d5 mentioned above is formed between the light emitting surface 220a of the light source 220 and the surface of the reflection layer 240. A second predefined gap having a set distance such as d6 is formed between the back surface 220b of the light source 220 and a corresponding surface of the reflection layer 240. Here, the distance (d6) of the second predefined gap is greater than the distance (d5) of the first predefined gap. Further, third and fourth predefined gaps having a set distance may be formed between the side surfaces 220d of the light source 220 and corresponding surfaces of the reflection layer 240. The third and/or fourth predefined gaps preferably have the set distance of d5, but can have other distance such as d6 or a distance value between d5 and d6. The lead electrodes 328, 329 are preferably disposed on or near the back surface 220b of the light source, but may be disposed at other locations.

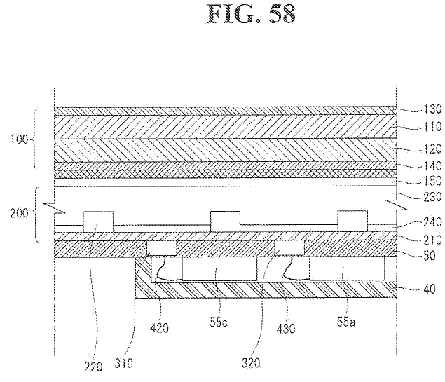

FIG. 57 illustrates an eighth exemplary configuration of a backlight unit according to the exemplary embodiment of the invention.

As shown in FIG. 57, the first layer 210, the plurality of light sources 220 formed on the first layer 210, the second layer 230 covering the plurality of light sources 220, and the reflection layer 240 formed on the first layer 210 that are described with reference to FIGS. 4 to 56B may configure one optical assembly 10. And the backlight unit 200 may be configured by disposing the above optical assembly 10 in plural.

The plurality of optical assemblies 10 included in the backlight unit 200 may be arranged in N by M matrix form in the x-axis and y-axis directions, where N and M are natural numbers equal to or greater than 1.

As shown in FIG. 57, 21 optical assemblies 10 of the backlight unit 200 may be arranged in 7×3 matrix. However, since the assembly arrangement shown in FIG. 57 is just one example for describing the backlight unit according to the embodiment of the invention, the embodiments of the invention are not limited thereto. The arrangement of the optical assemblies 10 may be changed depending on the screen size of the display device, etc. For example, in case of a 47-inch display device, the backlight unit 200 may be configured by arranging 240 optical assemblies 10 in 24×10 matrix.

Each of the optical assemblies 10 may be fabricated as an independent assembly, and the optical assemblies 10 may be disposed adjacent to one another to form a module-type backlight unit. The module-type backlight unit serving as backlight unit may provide light to the display panel 100.

As described above, the backlight unit 200 may be driven in a full driving manner such as global dimming or a partial driving manner such as local dimming and impulsive driving. The backlight unit 200 may be driven in various driving manners depending on a circuit design. As a result, in the embodiment of the invention, a color contrast ratio can increase, and also the image quality can be improved because a bright image and a dark image may be clearly displayed on the screen of the display device.

In other words, the backlight unit 200 may be divided into a plurality of division driving regions to operate and such regions may be independently and selectively driven (e.g., selectively dimmed, brightened, turned off/on, etc.). More specifically, the backlight unit 200 may reduce a luminance of a dark image and increase a luminance of a bright image based on a relation between a luminance of each of the division driving regions and a luminance of a video signal, thereby improving the contrast ratio and the definition.

For example, the backlight unit 200 may upwardly provide light by independently driving only some of the plurality of optical assemblies 10. For this, the light sources 220 included in the each of the optical assemblies 10 may be independently controlled.

An area of the display panel 100 corresponding to one optical assembly 10 may be divided into two or more blocks. The display panel 100 and the backlight unit 200 may be separately driven in block unit.

Because the plurality of optical assemblies 10 are assembled as described above to configure the backlight unit 200, a manufacturing process of the backlight unit 200 may be simplified and a manufacturing loss generated in the manufacturing process may be minimized. Hence, productivity of the backlight unit 200 may be improved. Further, the optical assembly 10 according to the embodiment of the invention may be applied to the backlight unit having various sizes by standardizing the optical assembly 10 and mass-producing the standardized optical assembly 10.

When one of the plurality of optical assemblies 10 of the backlight unit 200 is defective, only the defective optical assembly is replaced without replacing all of the optical assemblies 10 of the backlight unit 200. Therefore, a replacing work is easy and the part replacing cost is saved.

FIG. 58 is a cross-sectional view illustrating a configuration of a display device according to the exemplary embodiment of the invention. Structures and components identical or equivalent to those illustrated in FIGS. 1 to 57 may be designated with the same reference numerals in FIG. 58, and a further description may be briefly made or may be entirely omitted.

As shown in FIG. 58, the display panel 100 including the color filter substrate 110, the TFT substrate 120, the upper polarizing plate 130, and the lower polarizing plate 140 may closely adhere to the backlight unit 200 including the first layer 210, the plurality of light sources 220, and the second layer 230. For example, an adhesive layer 150 may be formed between the backlight unit 200 and the display panel 100 to adhesively fix the backlight unit 200 to the bottom of the display panel 100.

More specifically, the top of the backlight unit 200 may adhere to the bottom of the lower polarizing plate 140 using the adhesive layer 150. The backlight unit 200 may further include a diffuse sheet, and the diffuse sheet may closely adhere to the top of the second layer 230. In this case, the adhesive layer 150 may be formed between the diffuse sheet of the backlight unit 200 and the lower polarizing plate 140 of the display panel 100.

Further, a back plate 50 may be disposed on the bottom of the backlight unit 200 and may closely adhere to the bottom of the first layer 210.

The display device may include a display module 20, more particularly a power supply unit 55c for supplying a driving voltage to the display panel 100 and the backlight unit 200. For example, the plurality of light sources 220 of the backlight unit 200 may be driven (collectively as one or selectively in separate groups) using the driving voltage received from the power supply unit 55c to emit light.

The power supply unit 55c may be disposed and fixed onto the back plate 50 covering a back surface of the display module 20, so that the power supply unit 55c is stably supported and fixed.

In the embodiment of the invention, a first connector 310 may be formed on a back surface of the first layer 210. For this, a hole for inserting the first connector 310 may be formed in the back plate 50.

The first connector 310 may electrically connect the power supply unit 55c with the light source 220 to allow the driving voltage supplied by the power supply unit 55c to be supplied to the light source 220.

For example, the first connector 310 may be formed on the bottom of the first layer 210 and may be connected to the power supply unit 55c through a first cable 420. Hence, the first connector 310 may be used to transfer the driving voltage received from the power supply unit 55c through the first cable 420 to the light source 220.

An electrode pattern, for example, a carbon nanotube electrode pattern may be formed on the top of the first layer 210. The electrode formed on the top of the first layer 210 may contact the electrode formed in the light source 220 and may electrically connect the light source 220 with the first connector 410.

Further, the display device may include a driving controller 55a for controlling a drive of the display panel 100 and the backlight unit 200. For example, the driving controller 55a may be a timing controller.

The timing controller may control a driving timing of the display panel 100. More specifically, the timing controller may generate a control signal for controlling a driving timing of each of a data driver, a gamma voltage generator, and a gate driver that are included in the display panel 100 and may supply the control signal to the display panel 100.

The timing controller may synchronize with a drive of the display panel 100 and may supply a signal for controlling driving timing of the light sources 220 to the backlight unit 200, so that the backlight unit 200, more specifically, the light sources 220 operate.

As shown in FIG. 58, the driving controller 55a may be disposed and fixed onto the back plate 50 positioned on a back surface of the display module 20, so that the driving controller 55a may be stably supported and fixed.

In the embodiment of the invention, a second connector 320 may be formed on the first layer 210. For this, a hole for inserting the second connector 320 may be formed in the back plate 50.

The second connector 320 may electrically connect the driving controller 55a with the first layer 210, thereby allowing a control signal output from the driving controller 55a to be supplied to the first layer 210.

For example, the second connector 320 may be formed on the bottom of the first layer 210 and may be connected to the driving controller 55a through a second cable 430. Hence, the second connector 320 may be used to transfer a control signal received from the driving controller 55a through the second cable 430 to the first layer 210.

A light source driver may be formed on the first layer 210. The light source driver may drive the light sources 220 using the control signal(s) supplied from the driving controller 55a through the second connector 320.

The driving controller 55a and the power supply unit 55c may be covered by the hack cover 40 and may be protected from the outside.

The configuration of the display device shown in FIG. 58 is just one embodiment of the invention. Therefore, the location or the numbers of each of the driving controller 55a, the power supply unit 55c, the first and second connector 310 and 320, and the first and second cables 420 and 430 may be changed, if necessary.

Although embodiments have been described with reference to a number of illustrative embodiments thereof, it should be understood that numerous other modifications and embodiments can be devised by those skilled in the art that will fall within the scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A light generating device comprising:
a first layer;
a plurality of light source devices disposed on the first layer and configured to emit light from side surfaces of the light source devices, at least one of the light source devices having a light emitting diode and at least one lead electrode electrically connected to the light emitting diode, each of the at least one lead electrode being disposed in at least one lead electrode area of the corresponding light source device;
a reflection layer configured to reflect the light emitted from the light source devices,
the reflection layer disposed on the first layer and defining at least one predetermined gap between the at least one lead electrode area of the corresponding light source device and the reflection layer; and
a second layer covering the light source devices and the reflection layer.

2. The light generating device of claim 1, further comprising:
a pattern layer disposed on or in the second layer and including a plurality of patterns corresponding to the light source devices.

3. The light generating device of claim 1, wherein the second layer encapsulates the light source devices and the reflection layer.

4. The light generating device of claim 1, wherein for at least one of the light source devices, the at least one predetermined gap provided by the reflection layer includes a plurality of predetermined gaps extending along four different sides of the corresponding light source device.

5. The light generating device of claim 4, wherein the plurality of predetermined gaps have different lengths.

6. The light generating device of claim 4, wherein the four different sides of the corresponding light emitting device include a first side having a light emitting surface and a second side opposite the first side, and
a length of the predetermined gap extending along the second side is greater than a length of the predetermined gap extending along the first side.

7. The light generating device of claim 1, wherein the reflection layer includes a conductive material.

8. The light generating device of claim 1, wherein for at least one of the light source devices, the at least one predetermined gap provided by the reflection layer extends along three different sides of the corresponding light source device.

9. The light generating device of claim 8, wherein the three different sides of the corresponding light source device along which the at least one predetermined gap extends includes:
a side not having a light emitting surface, and
two sides adjacent to the side not having the light emitting surface.

10. The light generating device of claim 8, wherein the three different sides of the corresponding light source device along which the at least one predetermined gap extends includes:
a side having a light emitting surface through which the light is emitted, and
two sides adjacent to the side having the light emitting surface.

11. The light generating device of claim 1, wherein the light source devices are disposed in arrays and emit the light in at least two different lateral directions.

12. The light generating device of claim 1, wherein the reflection layer includes first and second sub-reflection layers having different reflectances.

13. The light generating device of claim 1, wherein the light generating device is a backlight unit of a display device.

14. A display device comprising a backlight unit including the light generating device of claim 1.

15. A backlight device comprising:
a plurality of first arrays of light source devices and a plurality of second arrays of light source devices disposed on a first layer, the first and second arrays of light source devices configured to emit light in at least two different directions, at least one of the light source devices including a light emitting diode;
a reflection layer configured to reflect the light emitted from the first and second arrays of light source devices,
the reflection layer disposed on the first layer and surrounding the first and second arrays of light source devices with a plurality of predefined gaps,
at least one of the predefined gaps provided between the reflection layer and at least one of the light source devices; and
a second layer covering the reflection layer and the first and second arrays of light source devices.

16. The backlight device of claim 15, wherein for at least one of the light source devices, multiple predefined gaps are provided between the reflection layer and the corresponding light source device and extend along four different sides of the corresponding light source device.

17. The backlight device of claim 16, wherein the multiple predefined gaps have different lengths.

18. The backlight device of claim 16, wherein the four different sides of the corresponding light emitting device include a first side having a light emitting surface and a second side opposite the first side, and
a length of the predefined gap extending along the second side is greater than a length of the predefined gap extending along the first side.

19. The backlight device of claim 15, further comprising:
a pattern layer disposed on or in the second layer and including a plurality of patterns corresponding to the light source devices.

20. A display device comprising the backlight device of claim 15.
